(19) United States
(12) Patent Application Publication
(10) Pub. No.: US 2023/0403588 A1
(43) Pub. Date: Dec. 14, 2023

(54) MACHINE LEARNING DATA COLLECTION, VALIDATION, AND REPORTING CONFIGURATIONS

(71) Applicant: QUALCOMM Incorporated, San Diego, CA (US)

(72) Inventors: Rajeev KUMAR, San Diego, CA (US); Xipeng ZHU, San Diego, CA (US)

(21) Appl. No.: 17/806,453

(22) Filed: Jun. 10, 2022

(51) Int. Cl. H04W 24/10; G06N 20/00; H04L 41/16; H04W 24/02; G06K 9/62

(52) U.S. Cl. CPC H04W 24/10; G06N 20/00; H04L 41/16; H04W 24/02; G06K 9/6256

(57) ABSTRACT

A device in a wireless network may process information with machine learning associated with a model ID, a machine learning function, or a machine learning use case and report data via the wireless communication based on a configuration associated with the model ID, the machine learning function, or the machine learning use case. A device may provide a configuration for machine learning associated with a model ID, a machine learning function or, a machine learning use case; and may receive a report of data based on the configuration associated with the model ID, the machine learning function, or the machine learning use case.

### TECHNICAL FIELD

The present disclosure relates generally to communication systems, and more particularly, to wireless communication including machine learning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus processes information with machine learning associated with a model identifier (ID), a machine learning function, or a machine learning use case; and reports data via the wireless communication based on a configuration associated with the model ID, the machine learning function, or the machine learning use case.

In an aspect of the disclosure, a method, a computer-readable medium, and an apparatus are provided. The apparatus provides a configuration for machine learning associated with a model ID, a machine learning function or, a machine learning use case; and receives a report of data based on the configuration associated with the model ID, the machine learning function, or the machine learning use case.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network, in accordance with various aspects of the present disclosure.

FIG. 4 is a diagram showing aspects of a machine learning or artificial intelligence training and inference, in accordance with various aspects of the present disclosure.

FIG. 5 illustrates example observations for a machine learning model based on different combinations of features and labels, in accordance with various aspects of the present disclosure.

FIG. 6 illustrates an example communication flow including a configuration of a measurement object and reporting based on the configuration.

FIG. 7 illustrates a communication flow that includes example aspects of data collection and validation for a machine learning model, in accordance with various aspects of the present disclosure.

FIG. 8 illustrates a communication flow that includes example aspects of data collection and validation for a machine learning model, in accordance with various aspects of the present disclosure.

FIG. 9 illustrates a communication flow that includes example aspects of data collection and validation for a machine learning model, in accordance with various aspects of the present disclosure.

FIG. 10 illustrates a communication flow that includes example aspects of data collection and validation for a machine learning model, in accordance with various aspects of the present disclosure.

FIG. 11 illustrates a communication flow that includes example aspects of data collection and validation for a machine learning model, in accordance with various aspects of the present disclosure.

FIG. 12 illustrates example aspects of data collection, processing, and validation for a machine learning model, in accordance with various aspects of the present disclosure.

FIG. 13 illustrates a communication flow that includes example aspects of data collection and validation for a machine learning model, in accordance with various aspects of the present disclosure.

FIG. 14A and FIG. 14B are flowcharts of a method of wireless communication, in accordance with various aspects of the present disclosure.

FIG. 15A and FIG. 15B are flowcharts of a method of wireless communication, in accordance with various aspects of the present disclosure.

FIG. 16 is a diagram illustrating an example of a hardware implementation for an example apparatus.

FIG. 17 is a diagram illustrating an example of a hardware implementation for an example network entity.

FIG. 18 is a diagram illustrating an example flowchart of a method of model registration, in accordance with various aspects of the present disclosure.

FIG. 19 is a diagram illustrating an example of a hardware implementation for an example model registration.

### DETAILED DESCRIPTION

Performance of an artificial intelligence (AI) or machine learning (ML) model may depend on the quality of the datasets used in connection with the AI/ML model. As an example, a large number of unnecessary feature spaces (which may be referred to as input parameters) may result in overfitting. For example, overfitting may refer to model predictions or inferences on field data that lose accuracy, e.g., low accuracy due to biases towards training data, in order to fit the training input data. The selection of the feature space (e.g., the input parameter set) may help to avoid overfitting. Principle component analysis (PCA) techniques may be used to select the feature space (e.g., input parameters set) to improve AI/ML performance by avoiding overfitting.

Similarly, an imbalanced dataset may negatively impact the AI/ML model performance. For example, if there is a greater number of observations for one class than for another, then the AI/ML model may tend to overfit towards the class having more observations. In order to avoid having unbalanced observations in the dataset, the data may be independently and identically distributed (i.i.d.).

Aspects presented herein provide for AI/ML data collection, reporting, and/or validation aspects that can improve the AI/ML performance. Aspects presented herein provide for the data collection and reporting (including the processing of the data for inference or training) to be configured and requested per AI/ML model identifier (ID), per AI/ML use case, or per AI/ML function. Aspects presented herein further provide for data validation to determine if collected data meets criteria to be included for training and inference based on the AI/ML model. The aspects presented herein may help to reduce the use of over-the-air resources by processing and reporting validated data and skipping the processing and/or reporting of data that does not meet validation criteria. Aspects presented herein may also help to reduce inference and online-training delay by reducing a data processing delay.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

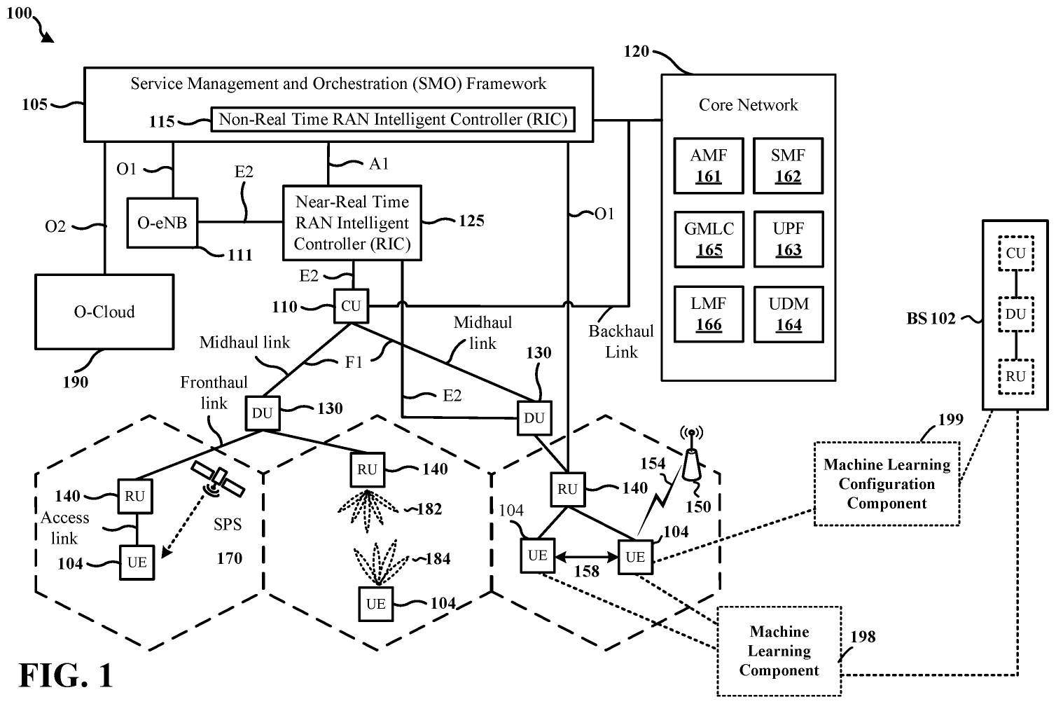

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers are illustrated as including a Gateway Mobile Location Center (GMLC) 165 and a Location Management Function (LMF) 166. However, generally, the one or more location servers may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a UE 104 and/or a base station 102 may include a machine learning component 198 that is configured to process information with machine learning associated with a model identifier (ID), a machine learning function, or a machine learning use case; and report data via the wireless communication based on a configuration associated with the model ID, the machine learning function, or the machine learning use case. A UE and/or a base station 102 may include a machine learning configuration component 199 that is configured to provide a configuration for machine learning associated with a model ID, a machine learning function or, a machine learning use case; and receive a report of data based on the configuration associated with the model ID, the machine learning function, or the machine learning use case.

Although the following description may be focused on 5G NR, the concepts described herein may be applicable to other similar areas, such as LTE, LTE-A, CDMA, GSM, and other wireless technologies.

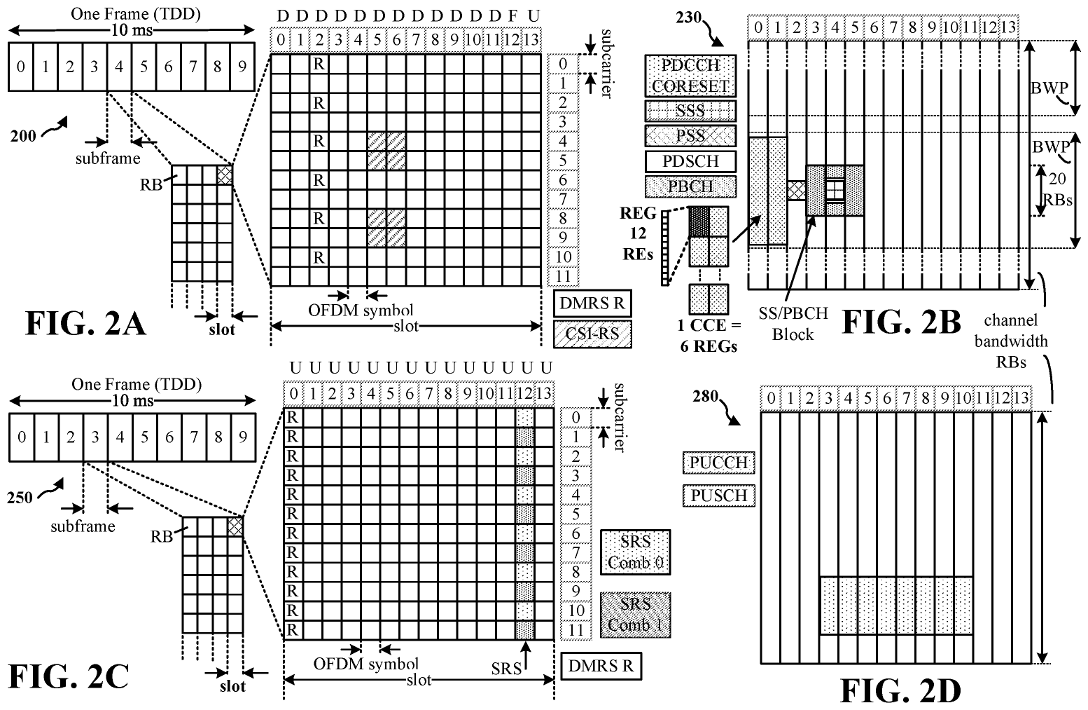

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | Cyclic |
|---|---|---|
| μ | Δf = 2^{μ} · 15 [KHz] | prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIB s), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

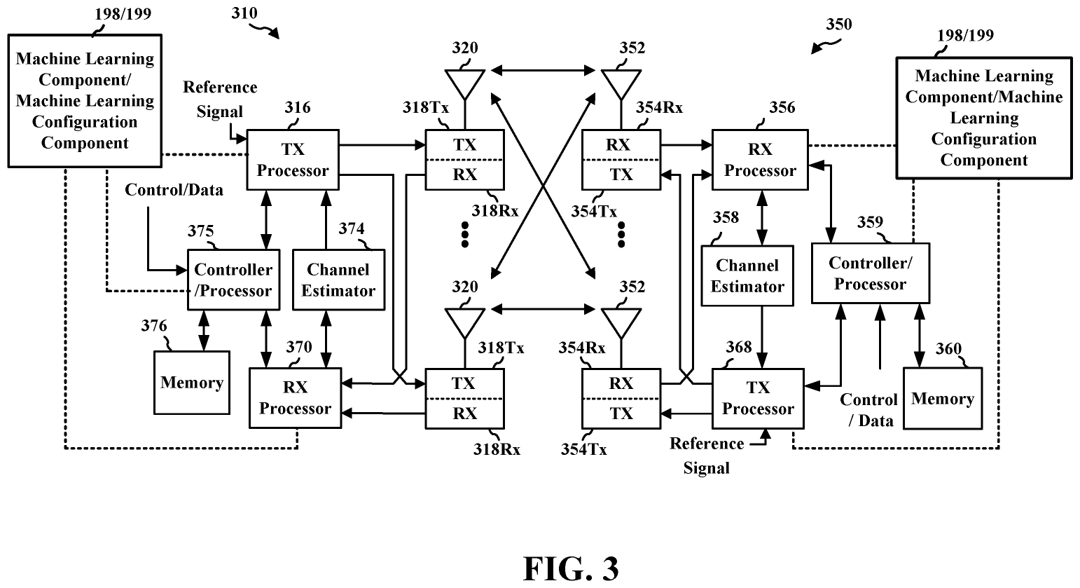

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIB s), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the machine learning component 198 and/or the machine learning configuration component 199 of FIG. 1.

At least one of the TX processor 316, the RX processor 370, and the controller/processor 375 may be configured to perform aspects in connection with the machine learning component 198 and/or the machine learning configuration component 199 of FIG. 1.

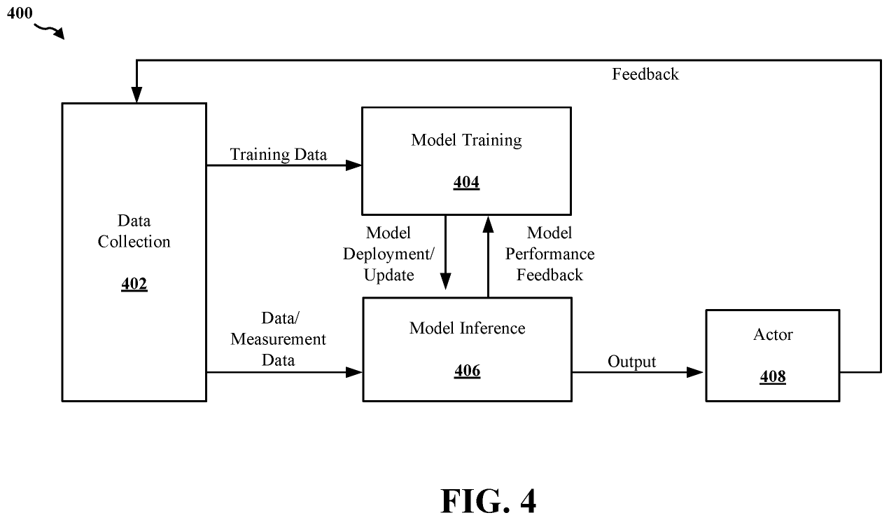

FIG. 4 an example of the AI/ML algorithm 400 that may be used in connection with wireless communication. The AI/ML algorithm 400 may include various functions including a data collection 402, a model training function 404, a model inference function 406, and an actor 408.

The data collection 402 may be a function that provides input data to the model training function 404 and the model inference function 406. The data collection 402 function may include any form of data preparation, and it may not be specific to the implementation of the AI/ML algorithm (e.g., data pre-processing and cleaning, formatting, and transformation). The examples of input data may include, but not limited to, radio measurements, such as a reference signal received power (RSRP) for a cell and/or a beam, from UEs or network nodes, feedback from the actor 408, output from another AI/ML model. As an example, the measurements may be of a reference signal such as a CSI-RS, or a precoding metric, among other examples. The data collection 402 may include training data, which refers to the data to be sent as the input for the AI/ML model training function 404, and inference data, which refers to be sent as the input for the AI/ML model inference function 406.

The model training function 404 may be a function that performs the ML model training, validation, and testing, which may generate model performance metrics as part of the model testing procedure. The model training function 404 may also be responsible for data preparation (e.g. data pre-processing and cleaning, formatting, and transformation) based on the training data delivered or received from the data collection 402 function. The model training function 404 may deploy or update a trained, validated, and tested AI/ML model to the model inference function 406, and receive a model performance feedback from the model inference function 406.

The model inference function 406 may be a function that provides the AI/ML model inference output (e.g. predictions or decisions). The model inference function 406 may also perform data preparation (e.g. data pre-processing and cleaning, formatting, and transformation) based on the inference data delivered from the data collection 402 function. The output of the model inference function 406 may include the inference output of the AI/ML model produced by the model inference function 406. The details of the inference output may be use-case specific. As an example, the output may include a predicted beam (e.g., for a beam measurement use case), a predicted CSI-RS RSRP and/or precoding metric (e.g., for a CSI feedback use case), a predicted UE position (e.g., for a positioning use case), among other examples. In some aspects, the actor may be a UE. In some aspects, the actor may be a network node. In some aspects, the UE may report the output to a network node or to another UE. In some aspects, the actor may be a network node. The network node may report the output to a UE or to another network node.

The model performance feedback may refer to information derived from the model inference function 406 that may be suitable for improvement of the AI/ML model trained in the model training function 404. The feedback from the actor 408 or other network entities (via the data collection 402 function) may be implemented for the model inference function 406 to create the model performance feedback.

The actor 408 may be a function that receives the output from the model inference function 406 and triggers or performs corresponding actions. The actor may trigger actions directed to network entities including the other network entities or itself. The actor 408 may also provide a feedback information that the model training function 404 or the model interference function 406 to derive training or inference data or performance feedback. The feedback may be transmitted back to the data collection 402.

The network may use machine-learning algorithms, deep-learning algorithms, neural networks, reinforcement learning, regression, boosting, or advanced signal processing methods for aspects of wireless communication including the identification of neighbor TCI candidates for autonomous TCI candidate set updates based on DCI selection of a TCI state.

In some aspects described herein, the network may train one or more neural networks to learn dependence of measured qualities on individual parameters. Among others, examples of machine learning models or neural networks that may be comprised in the network entity include artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; bayesian networks; genetic algorithms; Deep convolutional networks (DCNs) configured with additional pooling and normalization layers; and Deep belief networks (DBNs).

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model may include multiple layers and/or operations that may be formed by concatenation of one or more of the referenced operations. Examples of operations that may be involved include extraction of various features of data, convolution operations, fully connected operations that may be activated or deactivates, compression, decompression, quantization, flattening, etc. As used herein, a “layer” of a machine learning model may be used to denote an operation on input data. For example, a convolution layer, a fully connected layer, and/or the like may be used to refer to associated operations on data that is input into a layer. A convolution A×B operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained machine learning model. Different layers of a machine learning model may be trained separately.

Machine learning models may include a variety of connectivity patterns, e.g., including any of feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same, or similar, connectivity pattern, but with different connection strengths.

A machine learning model or neural network may be trained. For example, a machine learning model may be trained based on supervised learning. During training, the machine learning model may be presented with input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

The machine learning models may include computational complexity and substantial processor for training the machine learning model. An output of one node is connected as the input to another node. Connections between nodes may be referred to as edges, and weights may be applied to the connections/edges to adjust the output from one node that is applied as input to another node. Nodes may apply thresholds in order to determine whether, or when, to provide output to a connected node. The output of each node may be calculated as a non-linear function of a sum of the inputs to the node. The neural network may include any number of nodes and any type of connections between nodes. The neural network may include one or more hidden nodes. Nodes may be aggregated into layers, and different layers of the neural network may perform different kinds of transformations on the input. A signal may travel from input at a first layer through the multiple layers of the neural network to output at a last layer of the neural network and may traverse layers multiple times.

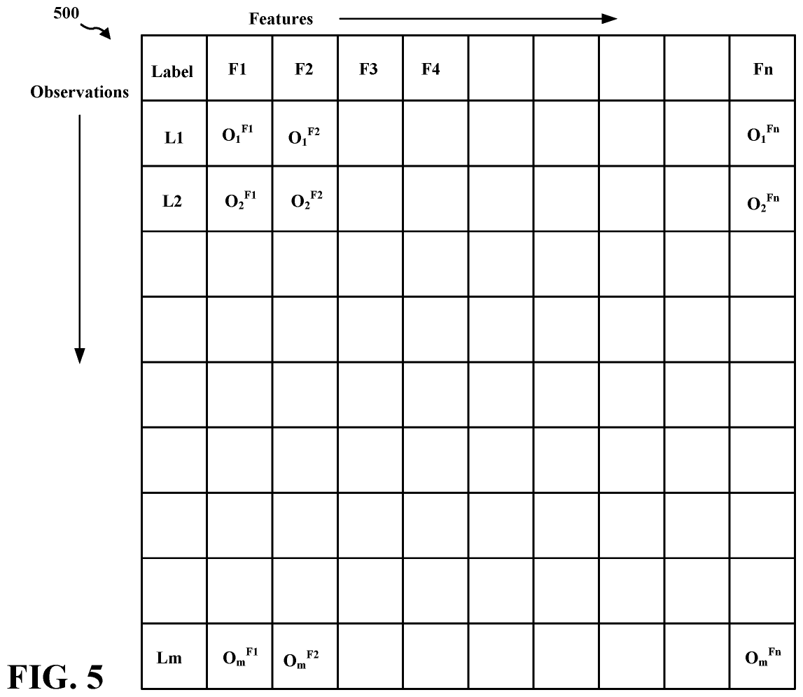

Performance of an AI or ML model performance may depend on the quality of the datasets used in connection with the AI/ML model. FIG. 5 illustrates an example diagram 500 showing different observations, e.g., O₁^{F1}, O₂^{F1}, O₁^{F2}, . . . , Oₘ^{Fn}, that may be observed for a combination of labels, e.g., L₁, L₂, to Lₘ, and features, e.g., F₁, F₂, to Fₙ. As an example, a large number of unnecessary feature space (which may be referred to as input parameters) may result in overfitting. For example, overfitting may refer to model predictions or inferences that lose accuracy when used for field data (or real-world data), e.g., low accuracy due to biases towards training data, in order to fit training input data. The selection of the feature space (e.g., the input parameter set) may help to avoid overfitting. Principle component analysis (PCA) techniques may be used to select the feature space (e.g., input parameters set) to improve AI/ML performance by avoiding overfitting.

Similarly, an imbalanced dataset may negatively impact the AI/ML model performance. For example, if there is a greater number of observations for one class than for another, then the AI/ML model may tend to overfit towards the class having more observations. In order to avoid having unbalanced observations in the dataset, the data may be independently and identically distributed (i.i.d.).

Aspects presented herein provide for AI/ML data collection, reporting, and/or validation aspects that can improve the AI/ML performance. Aspects presented herein provide for the data collection and reporting (including the processing of the data for inference or training) to be configured, e.g., configured for a UE by a network node or another UE, requested by UE from a network node or another UE, configured for a network node by another network node, among other examples. Aspects presented herein further provide for data validation to determine if collected data meets criteria to be included for training and inference based on the AI/ML model. The aspects presented herein may help to reduce the use of over-the-air resources by processing and reporting validated data and skipping the processing and/or reporting of data that does not meet validation criteria. Aspects presented herein may also help to reduce inference and online-training delay by reducing a data processing delay.

There are various AI/ML inference and/or training use cases and related data processing procedures for application in a wireless network. As a first example, the AI/ML training and inference may be performed at a UE using UE data. In such an example, a model designer (e.g., a UE or a UE vendor) may determine a most significant feature space (e.g., the input parameter set), which may use PCA. The data for training and inference may then be collected at the UE, e.g., as described in connection with the example in FIG. 4. The UE may perform data validation, e.g., determining whether the data is balanced. In some aspects, the data validation may be based on i.i.d. so that the validated data follows a defined set of statistics or criteria.

In another example, the training and inference may be performed at the UE using UE data and network data. In such an example, a model designer (e.g., a UE or a UE vendor) may determine a most significant feature space (e.g., the input parameter set), which may use PCA. In some aspects, the UE may indicate to the network the data to be collected at the network. The data for training and/or inference may then be collected at the network and at the UE. The UE and the network may perform data validation, e.g., determining whether the data is balanced.

As another example, the AI/ML training and inference may be performed at a network node using network data. In such an example, a model designer (e.g., a network entity or network vendor) may determine a most significant feature space (e.g., the input parameter set), which may use PCA. The data for training and inference may then be collected at the network node, e.g., as described in connection with the example in FIG. 4. The network node may perform data validation, e.g., determining whether the data is balanced.

In another example, the training and inference may be performed at a network node using UE data and network data. In such an example, a model designer (e.g., a network entity or network vendor) may determine a most significant feature space (e.g., the input parameter set), which may use PCA. In some aspects, the network node may indicate to the UE the data to be collected at the UE. The data for training and/or inference may then be collected at the network and at the UE. The UE and the network may perform data validation, e.g., determining whether the data is balanced.

In another example, the training an interference may be performed at a UE, e.g., as configured by a network node. In such an example, a model designer (e.g., a network entity or network vendor) may determine a most significant feature space (e.g., the input parameter set), which may use PCA. The network node may configure the UE to perform the data training and/or inference based on the AI/ML model. The network node may provide a scheme for data validation to the UE. The UE performs data validation for training and/or inference according to the data validation scheme provided by the network node. In some aspects, the UE may perform training when the data validation succeeds and may skip training the AI/ML model if the data does meet the validation criteria according to the validation scheme provided by the network node.

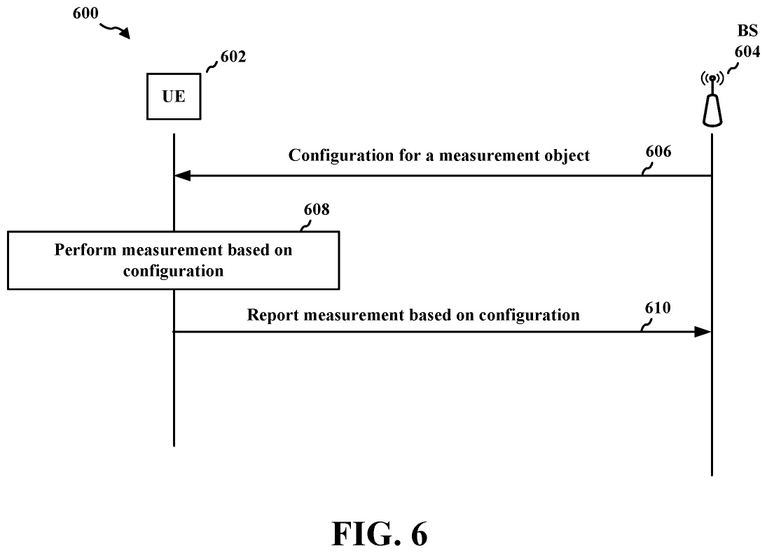

A UE may be configured by a network node with different measurement objects and identities are used for configuring the measurements. FIG. 6 illustrates an example communication flow 600 between a UE 602 and a base station 604, in which the base station 604 configures the UE with one or more measurement object and a reporting configuration, at 606. The UE 602 performs the measurement, at 608, as configured by the base station. At 610, the UE 602 reports the measurement to the base station based on the configuration received at 606. As an example, the base station may indicate to the UE 602 to measure CSI-RS and to report CSI to the base station.

Aspects presented herein provide for AI/ML based data collection, reporting, and validation by one or more devices in a wireless network. Aspects enable the input features for inference and online-training to be reported in a timely fashion and may help to minimize a processing delay associated with obtaining input features from the raw data (e.g., data observed at a UE and/or network node). Raw data may also be referred to as source data, atomic data or primary data. Raw data is data that has not been processed for use. The raw data is the data collected at the network or the UE and from which the input feature of the model may be derived. Aspects presented herein provide for the validation of input features before such input features are provided as input to inference and/or training engines. Aspects may also provide for the validation of output data before such data is reported to a network or a UE.

A large number of parameters may be configured at 606 for the measurements to be performed by the UE 602. Different AI/ML models, AI/ML function, and/or use cases may use different subsets of the configured measurements, such that at least a subset of the configured measurements may not be relevant for a particular AI/ML model, AI/ML function, or use case. For different AI/ML models, the input features (e.g., input parameters) may involve different conditions and periodicity for reporting. Aspects presented herein enable different measurement collection and/or reporting configurations to be provided with different conditions for measurement collection and/or reporting for different AI/ML models, AI/ML functions, and/or use cases. The measurements may be processed differently for different AI/ML models, AI/ML functions, or use cases. For example, normalization of measurements, filtering, and other validation of measurements may be used in connection with one or more AI/ML models, AI/ML function, or use cases, as the data validation may affect the AI/ML performance.

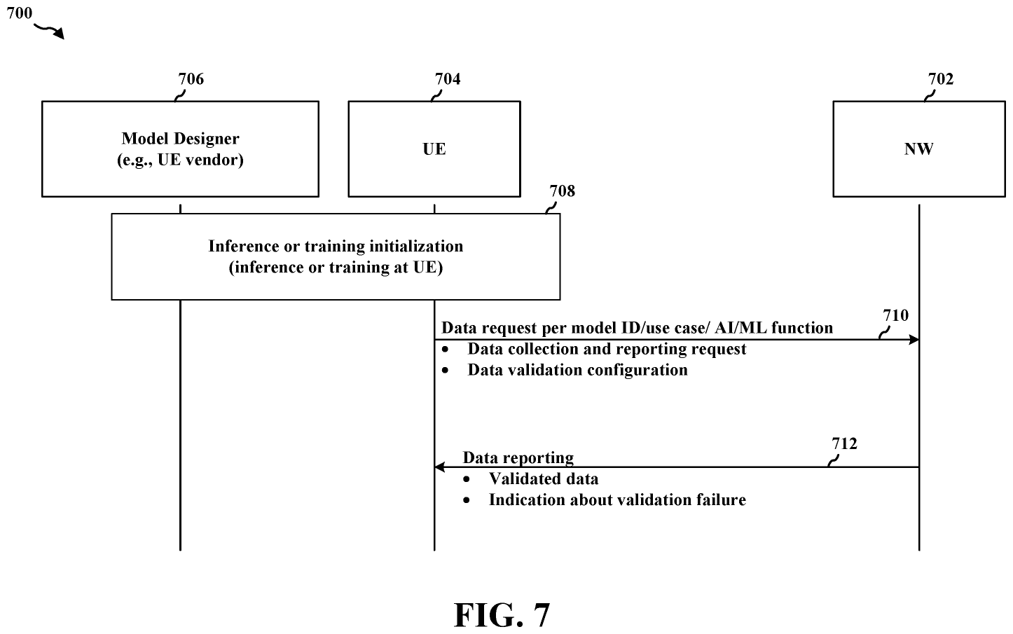

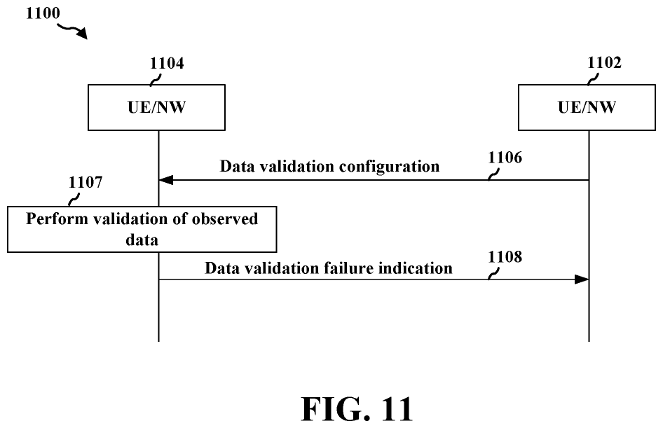

FIG. 7 illustrates a communication flow 700 that includes example aspects of data collection and validation for a machine learning model in which the inference, federated learning, and/or training occurs at the UE with network assistance. FIG. 7 shows that a model designer 706 may provide the UE 704 with an inference or training initialization, at 708. The model designer 706 may be a UE vendor or manufacturer, in some examples, and may configure the UE 704 with the inference or training initialization for the AI/ML model. In some aspects, the model designer 706 may provide UE 704 with inference or training initialization for multiple AI/ML models. As illustrated at 710, the UE 704 may request data from a network node 702, such as a base station or a component of a base station. The UE 704 may request data for one or more AI/ML models, and may indicate the requests per model identifier (ID) associated with the corresponding AI/ML model. In another example, the UE may request data for one or more AI/ML models for different AI/ML use cases. In another example, the UE may request data for one or more AI/ML models for different AI/ML functions. As an example of different ML model IDs, the UE 704 may request data for ML model 1 and ML model 5. As shown in FIG. 7, the request may indicate data for the network node 702 to collect and/or report. The request may indicate a data validation configuration that provides criteria for the data to meet in order for the network node 702 to report the data to the UE 704. Aspects of validation are described in connection with FIG. 11. At 712, the network node 702 may report the requested data or a failure indication to the UE 704. For example, if the network node 702 has collected and validated data in response to the request for ML model 1, the network node may report the validated data to the UE 704 at 712. If the data collected for the ML model 5 does not meet the validation criteria for ML model 5, the network node 702 may transmit a validation failure indication to the UE 704, at 712. Although an example is described for different ML model IDs in order to illustrate the concept, the aspects may similarly be applied for different AI/ML use cases or for different AI/ML functions rather than different ML Model IDs.

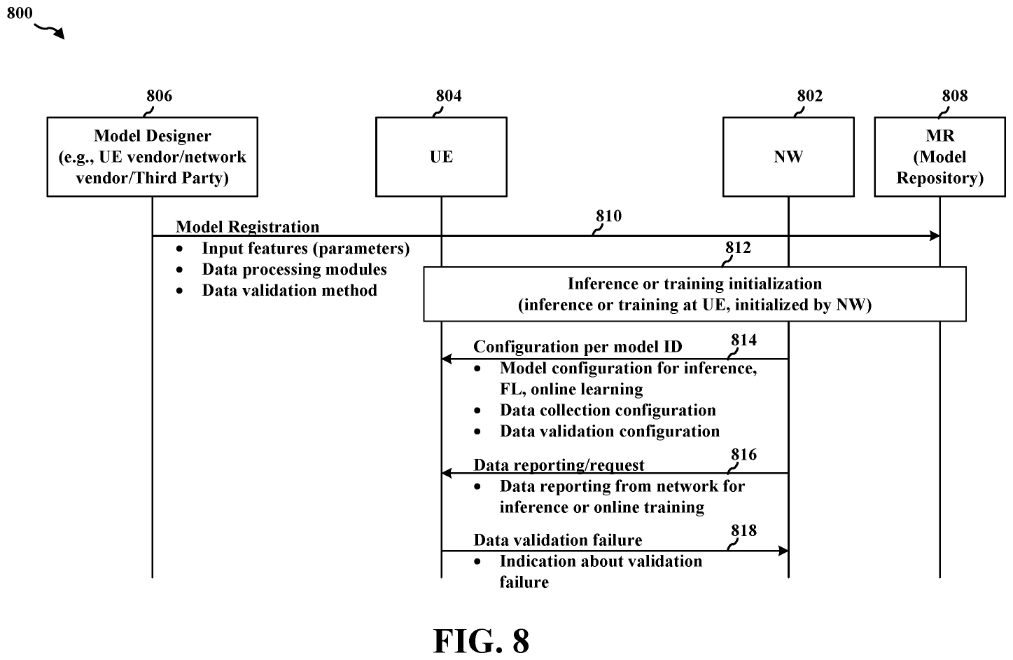

FIG. 8 illustrates a communication flow 800 that includes example aspects of data collection and validation for a machine learning model in which the inference, federated learning, and/or training occurs at the UE 804 with a network configuration and network assistance. FIG. 8 shows that a model designer 806 may register a AI/ML for inference or training, at 810. During the model registration, a model designer 806 may provide the input features (e.g., an input parameter set), data processing modules, and/or data validation information for the registered AI/ML model. The model may be registered and stored at a model repository 808 at the network, for example. The model designer 806 may be a UE vendor or manufacturer, a network vendor, or a third part. As illustrated at 812, the UE 804 may receive inference or training initialization for the AI/ML model, e.g., from a network node 802. For the online training or federated learning at the UE(s), the training request for AI/ML model may be received from a network node 802 on request from the model repository 808. The network node 802 may similarly receive the inference and/or training initialization from the model repository 808. The network node 802 may be a base station, a component of a base station, or may implement base station functionality, for example. In some aspects, the model repository 808 may store model information for multiple AI/ML models. As illustrated at 814, the network node 802 may transmit to the UE 804 a configuration for one or more AI/ML models, and may indicate the configurations per model identifier (ID) associated with the corresponding AI/ML model. In another example, the network node 802 may configure the UE 804 to collect/process/report data for one or more AI/ML models for different AI/ML use cases. In another example, the network node 802 may configure the UE 804 to collect/process/report for one or more AI/ML models for different AI/ML functions. As an example of different ML model IDs, the network node 802 may configure the UE 804 to collect/process/report data for ML model 1 and ML model 5. As shown in FIG. 8, the configuration, at 814, may indicate for the UE to collect, process, validate, and/or report data to the network node 802. The configuration at 814 may indicate an AI/ML model configuration for inference, for federated learning, for online learning, etc. The configuration may indicate a data validation configuration that provides criteria for the data to meet in order for the UE 804 to report the data to the network node 802. Aspects of validation are described in connection with FIG. 11. At 816, the network node 802 may provide data to the UE 804 and/or may request data from the UE 804. At 818, the UE 804 may report the requested data or a failure indication to the network node 802. For example, if the UE 804 has collected and validated data in response to the request for ML model 1, the UE 804 may report the validated data to the network node 802 at 818. If the data collected for the ML model 5 does not meet the validation criteria for ML model 5, the UE 804 may transmit a validation failure indication to the network node 802 at 818. Although an example is described for different ML model IDs in order to illustrate the concept, the aspects may similarly be applied for different AI/ML use cases or for different AI/ML functions rather than different ML Model IDs.

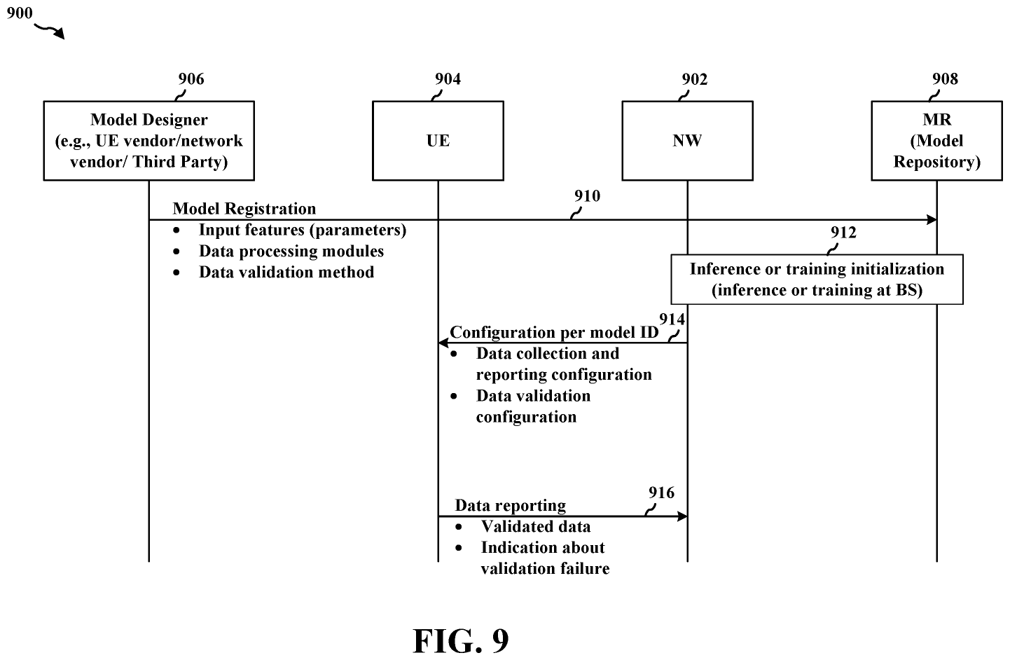

FIG. 9 illustrates an example communication flow 900 that includes example aspects of data collection and validation for a machine learning model in which the inference and/or training occurs at the network with UE assistance. FIG. 9 shows that a model designer 906 may register a AI/ML model for the inference or training, at 910. During the registration process, a model designer 906 may provide the input features (e.g., an input parameter set), data processing modules, and/or data validation information for the registered AI/ML model. The model may be registered and stored at a model repository 908 at the network, for example. The model designer 906 may be a UE vendor or manufacturer, a network vendor, or a third part. As illustrated at 912, the network node 902 may receive the inference and/or training initialization from the model repository 908. The network node 902 may be a base station, a component of a base station, or may implement base station functionality, for example. In some aspects, the model repository 908 may store model information for multiple AI/ML models. As illustrated at 914, the network node 902 may transmit to the UE 904 a configuration for one or more AI/ML models, and may indicate the configurations per model ID associated with the corresponding AI/ML model. In another example, the network node 902 may configure the UE 904 to collect and report data for one or more AI/ML models for different AI/ML use cases. In another example, the network node 902 may configure the UE 904 to collect and report data for one or more AI/ML models for different AI/ML functions. As an example of different ML model IDs, the network node 902 may configure the UE 904 to collect and report data for ML model 2 and ML model 3. As shown in FIG. 9, the configuration, at 914, may indicate for the UE to collect, validate, and/or report data to the network node 902. The configuration at 914 may indicate a data validation configuration that provides criteria for the data to meet in order for the UE 904 to report the data to the network node 902. Aspects of validation are described in connection with FIG. 11. At 916, the UE 904 may report the requested data or a failure indication to the network node 902. For example, if the UE 904 has collected and validated data in response to the request for ML model 2, the UE 904 may report the validated data to the network node 902 at 916. If the data collected for the ML model 3 does not meet the validation criteria for ML model 3, the UE 904 may transmit a validation failure indication to the network node 902 at 916. Although an example is described for different ML model IDs in order to illustrate the concept, the aspects may similarly be applied for different AI/ML use cases or for different AI/ML functions rather than different ML Model IDs.

In each of FIGS. 7, 8, and 9, the data collection and reporting per model ID, AI/ML use case, or AI/ML function helps to reduce inference delay and online training delay by helping to prepare data during the collection phase. The validation of the inference and training data helps to improve the AI/ML performance by selecting data following a set of characteristics and/or statistics in order to ensure that the data is authentic data or accurate data for training and/or inference purposes. The validation helps to avoid overfitting the AI/ML model to fit data that is not accurate.

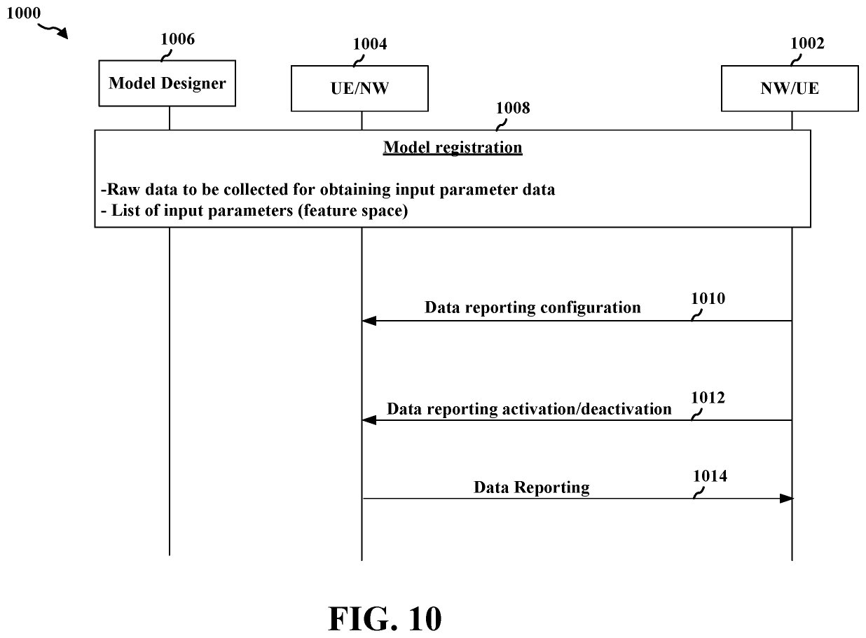

FIG. 10 illustrates an example communication flow 1000 between a first device 1004 and a second device 1002 in a wireless network including an AI/ML model ID based data request and report. In some aspects, the first device 1004 may be a UE and the second device 1002 may be a network node or a second UE. In other aspects, the first device 1004 may be a network node and the second device 1002 may be a UE or another network node. FIG. 10 illustrates that a model registration 1008 may occur in which a model designer 1006 registers input parameters of an AI/ML model including raw data to be collected for and from which input parameters are to be obtained for the AI/ML model. The model registration may also include an indication of one or more data processing modules to be used for obtaining the input parameters for the AI/ML model. The model registration may also include an indication of a list of one or more input parameters (e.g., a feature space) for the AI/ML model. In some aspects, PCA may be used by the model designer 1006 to determine a most significant feature space (e.g., input parameters set) for AI/ML model training and inference, e.g., as described in connection with the example aspects of training and inference in FIG. 4. The model designer 1006 may be a UE, a UE vendor or manufacturer, a network node, a network vendor, a third party, etc.

As illustrated at 1010, the second device 1002 may transmit a data reporting configuration to the first device 1004. The second device 1002 may be a base station, a component of a base station, or may implement base station functionality or may be a UE or UE vendor, e.g., based on the particular training and inference scenario. Various examples of training and inference scenarios are described in connection with FIGS. 7-9. The second device 1002 may transmit a data request per model ID for multiple AI/ML models, AI/ML use cases, or AI/ML functions, the request/configuration indicating AI/ML model or use case input parameters, raw data/measurement for the first device 1004 to compute input parameters, raw data to obtain model input parameters, data processing modules, or a method of data reporting for the corresponding AI/ML model. As an example, a network node (e.g., as the second device 1002) may configure these parameters per model ID, per use case, or per AI/ML function, e.g., in one or more RRC messages to a UE (e.g., as the first device 1004). In some aspects, a UE (e.g., as the second device 1002) may request the data from a network node (e.g., as the first device 1004) in a message including UE assistance information (UAI).

In some aspects, at 1012, the second device 1002 may activate or deactivate an AI/ML model, use case, of function that was configured at 1010. As an example, a network node (e.g., as the second device 1002) may transmit a MAC-CE or DCI to a UE (e.g., as the first device 1004) at 1012, that activates or deactivates data reporting for one or more AI/ML model IDs, use cases, or functions that were configured, at 1010. As another example, a UE (e.g., as the second device 1002) may transmit a MAC-CE or DCI to a network node or to another UE (e.g., as the first device 1004) at 1012, that activates or deactivates data reporting for one or more AI/ML model IDs, use cases, or functions that were configured, at 1010.

At 1014, the first device 1004 reports the data according to the configured (e.g., and activated) AI/ML model ID, use case, or function. The first device 1004 may transmit the data report in any combination of an RRC message, a MAC-CE, UCI, and/or DCI to the second device 1002.

FIG. 11 illustrates an example communication flow 1100 between a first device 1104 and a second device 1102 in a wireless network including an AI/ML model ID based data request and report. In some aspects, the first device 1104 may be a UE and the second device 1102 may be a network node or a second UE. In other aspects, the first device 1104 may be a network node and the second device 1102 may be a UE or another network node. In some aspects, the communication flow in FIG. 11 may be performed in connection with the communication flow in FIG. 10, e.g., as shown in the various examples in FIGS. 7-9.

At 1106, the second device 1002 transmits a data validation configuration to the first device 1004. For example, the data validation configuration may be provided to the first device 1004 in association with a data reporting configuration, e.g., such as 1010. In the data validation configuration, the configuring or requesting device (whether a UE or network node) can provide the rules or criteria for data validation. As an example, the second device 1002 may indicate a set of data statistics and/or properties that the AI/ML inference and training data are to follow for a particular model ID, use case, or AI/ML function. For example, the new data that is observed or measured by the first device 1004 may be checked for errors by comparing the newly observed data, at 1107, against the set of predefined data properties, statistics, criteria, or rules in the data validation configuration for the corresponding model ID, use case, or function. The data validation configuration may be provided to the second device 1002 per model ID/use case/or AI/ML function and may be provided together with a data collection and reporting configuration for the corresponding model ID, use case, or function, e.g., as described in connection with FIG. 8 and FIG. 9. Similarly, the data validation configuration for the model ID, use case, or function may be provided from a UE to the network in a UAI or other message, such as described in connection with FIG. 7.

As illustrated at 1108, the device 1104 may provide a data validation failure indication if the observed data does not meet the configured validation criteria. Otherwise, the device may report the data, e.g., as illustrated in any of FIGS. 7-10. For either inference or training (e.g., online training) including an AI/ML model, the data validation failure may be reported by the device 1104 in a timely fashion such that other device 1102 can take an appropriate action. For example, if the observed data is different than expected for a ML model, use case, or function, the second device 1002 may fall back to a different procedure. In some aspects, the device may fall back to a non-AI/ML model procedure, which may be referred to as a legacy procedure. In some aspects, the device 1104 may further indicate to the device 1102 information about the data validation (such as how closely the newly observed inference and/or training data is correlated with a defined set of statistics or properties). The device 1104 may provide the validation failure information per inference/on-line training occasion including a failure indication. In some aspects, the device 1104 may provide the information about the data validation in bulk, e.g., for multiple inferences or training occasions, together with a failure indication.

In some aspects, if the data indication fails, then the network node and/or the UE may fallback to a different procedure, such as a non-AI/ML measurement and reporting procedure. In some aspects, the validation failure indication, at 1108 may indicate the that device 1104 will switch to a different reporting procedure and/or may indicate to the device 1102 to use a non-AI/ML procedure for wireless communication with the device 1104. In some aspects, the reported data may be for federated learning. In such aspects, the validation failure indication 1108 may indicate to the device 1102 that the device 1104 did not obtain the weight for a particular epoch.

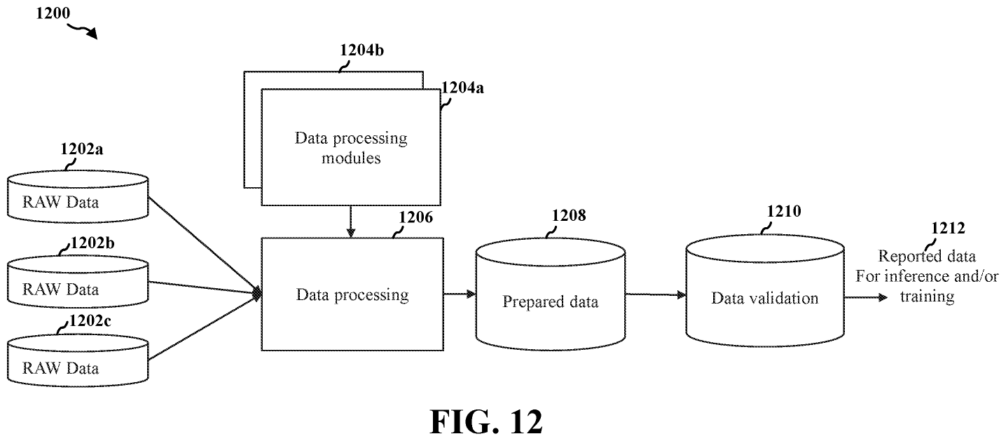

As an example, a network may request or indicate to a UE the data to be collected, processed, and/or reported per model ID, per use case, or per AI/ML function. As an example, for AI/ML training, federated learning, or inference at a network node, the network node may indicate the data processing modules/techniques to be used. FIG. 12 illustrates a data processing diagram 1200 showing that raw data from multiple sources or multiple observations, e.g., at 1202a, 1202b, 1202c, 1202d, may be processed at 1206 using one or more of multiple data processing modules 1204a or 1204b to provide prepared data 1208. The data processing modules 1204a and 1204b can include filtering, restructuring, transformations (including feature scaling, normalization, converting qualitative variables to quantitative variables, among other examples) and other modules/techniques to be used when the UE or a network node collects measurements for training or inference for a given model ID, use case, or AI/ML function. The prepared data may then be validated, at 1210, by comparing the processed data to the validation criteria, e.g., statistics, properties, rules, etc. If the processed data meets the validation criteria, the data may be reported, used for an inference, and/or used for training, at 1212. FIG. 4 illustrates various aspects of training and inference, and FIGS. 7-10 illustrate various aspects of reporting. FIG. 11 illustrates various aspects of providing a validation failure indication and/or validation failure information if the processed data does not meet the validation criteria. The network may provide configuration for training and inference data validation, e.g., as described in connection with any of FIGS. 7-11. For federated learning, a network may configure data processing and validation, e.g., before the data is used for federated learning.

Similarly, a UE may request or indicate to a network node or another UE the data to be collected, processed, and/or reported per model ID, per use case, or per AI/ML function. The UE may request the training or inference data per model ID, use case, or AI/ML function from the network using UAI, in some aspects. In some aspects, the UE may indicate feature spaces/parameters for the network node or other UE to reported to the requesting UE. In some aspects, the UE may indicate a set of raw data from which the input features/parameters are to be obtained for the AI/ML model. In some aspects, the UE may indicate data and processing modules/techniques, e.g., 1204a or 1204b, to be used for the data collection and/or reporting. In some aspects, the UE may indicate a configuration for training and/or inference data validation, at 1210, to be performed before data is reported to the UE.

As described in connection with FIG. 7, a UE may request network assistance data per model ID/use case/ML function for inference, federated learning, or training (online and/or offline training) at the UE, e.g., by providing a list of input features (e.g., input parameters) for the model ID/use case/function, data processing modules, and/or validation methods for the model ID/use case/function.

For inference, federated learning, or training (online and offline training) at the network, e.g., as in FIG. 8 or 9, the network may provide the data collection, reporting, and validation configuration per model ID/use case/ML function. In response, the UE may collect and report the requested measurements per model ID/use case/ML function. If a validation failure occurs, e.g., as described in connection with FIG. 11, the UE may indicate the validation failure to the network.

From a perspective of the network node, the network may provide a configuration for the data collection, reporting, and validation per model ID/use case/ML function, as described in connection with any of FIGS. 8-10. The network may provide the data processing models to be used for the processing of the data before reporting to the network. The network may provide the data validation methods, criteria, or statistics that collected inference or training data is to follow to be considered legitimate for inference or training of the AI/ML model. Upon a data request from the UE (including the data validation method), the network may report the data to the UE after validation, e.g., as described in connection with FIG. 7. If the requested data is not available or does not satisfy the validation scheme, the network may indicate it to UE, e.g., as described in connection with FIG. 11.

As described in connection with any of FIGS. 7-10, the model designer may register the model, and at the time of registration, may provide a list of input feature, data processing modules for obtaining the input features, and/or data validation schemes (such as baseline statistics that inference or training data is to follow). The information provided by the model designer may be used by the network node and/or UE in configuring, requesting, collecting, processing, validating, and/or reporting data in connection with an AI/ML model, use case, and/or function.

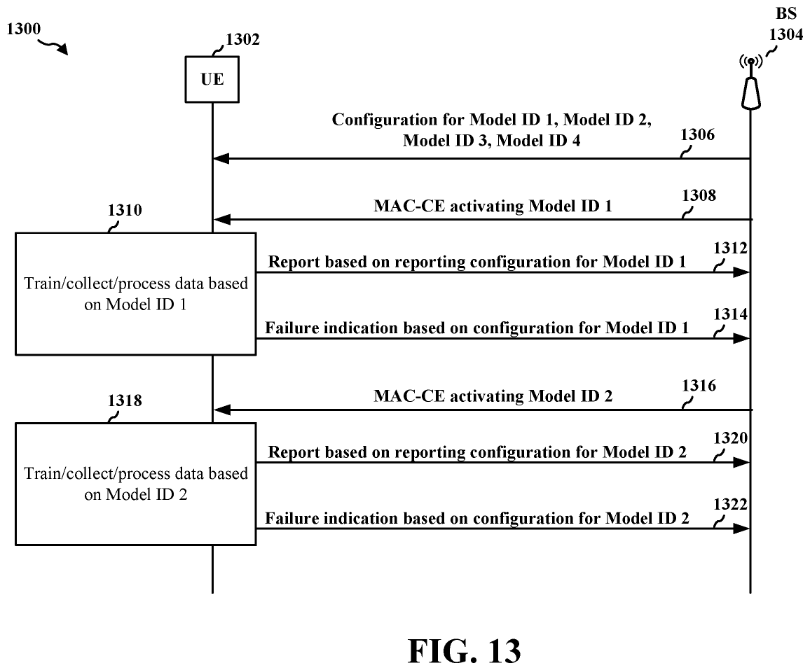

FIG. 13 illustrates an example communication flow 1300 between a UE 1302 and a base station 1304 that illustrates that concept of multiple AI/ML models being configured and one or more of the configured models being activated for data collection/processing/reporting. Although the aspects are described for a UE and a network, the aspects performed by the UE 1302 may be performed by a network node, and/or the aspects performed by the base station 1304 may be performed by a UE, e.g., depending on the device that requests the data to be collected and reported, e.g., as in the different AI/ML scenarios described in connection with FIGS. 7-10.

At 1306, the UE 1302 may receive configurations for multiple AI/ML models, such as AI/ML model 1, AI/ML model 2, AI/ML model 3, and AI/ML model 4. The UE 1302 may receive the configurations separately or together. At 1308, the base station 1304 may transmit a MAC-CE, or a DCI, that activates the AI/ML model 1. At 1310, the UE 1302 may collect data for training, inference, and/or reporting, based on AI/ML model 1. The UE may also validate the data using criteria from the configuration, at 1306, such as described in connection with FIG. 11. If the data meets the validation criteria for the AI/ML model 1, the UE may report the data, at 1312. If the data does not meet the validation criteria for the AI/ML model 1, the UE may provide a failure indication, at 1314.

At 1316, the base station 1304 may transmit a MAC-CE, or a DCI, that activates the AI/ML model 2. In some aspects, the base station may deactivate the AI/ML model 1, and the UE may cease the training/collection/validation/reporting based on the model 1. In some aspects, the activation of the model 2 may indicate a deactivation of the model 1. In other aspects, the UE may continue to collect and report data based on the model 1 and may also collect and report data based on the model 2 in response to the activation. At 1318, the UE 1302 may collect data for training, inference, and/or reporting, based on AI/ML model 2. The UE may also validate the data using criteria from the configuration, at 1306, such as described in connection with FIG. 11. If the data meets the validation criteria for the AI/ML model 2, the UE may report the data, at 1320. If the data does not meet the validation criteria for the AI/ML model 1, the UE may provide a failure indication, at 1322.

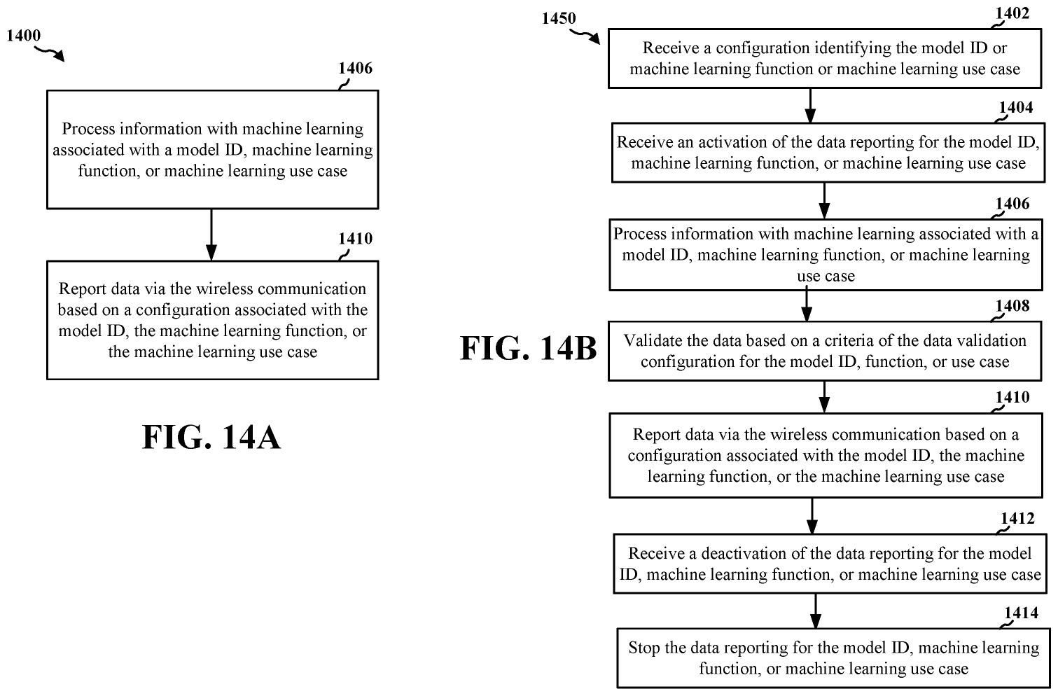

FIG. 14A is a flowchart 1400 of a method of wireless communication. In some aspects, the method may be performed by a UE (e.g., the UE 104, 350, 602, 704, 804, 904, 1302, the first device 1004, 1104; the apparatus 1604). In some aspects, the method may be performed by a network node such as a base station, a component of a base station or a device implementing base station functionality (e.g., the base station 102, 310, 1304; network node 702, 802, 902; the first device 1004, 1104; the network entity 1702.

At 1406, the device processes information with machine learning associated with a model ID, a machine learning function, or a machine learning use case. The processing may be performed, e.g., by the machine learning component 198. The processing may include any of the aspects described in connection with FIG. 4, 5, or 7-13.

At 1410, the device reports data via the wireless communication based on a configuration associated with the model ID, the machine learning function, or the machine learning use case. The reporting may be performed, e.g., by the machine learning component 198. The reporting may include any of the aspects described in connection with any of FIG. 7-10, 12, or 13, for example. The configuration associated with the model ID, the machine learning function, or the machine learning use case may indicate one or more of: a data reporting method, at least one input parameter for the machine learning, unprocessed data to obtain model input parameters, at least one measurement to obtain the model input parameters, at least one data processing module, timing for the data reporting, a condition for the data reporting, or a periodicity for the data reporting.

FIG. 14B is a flowchart 1450 of a method of wireless communication. In some aspects, the method may be performed by a UE (e.g., the UE 104, 350, 602, 704, 804, 904, 1302, the first device 1004, 1104; the apparatus 1604). In some aspects, the method may be performed by a network node such as a base station, a component of a base station or a device implementing base station functionality (e.g., the base station 102, 310, 1304; network node 702, 802, 902; the first device 1004, 1104; the network entity 1702.

At 1406, the device processes information with machine learning associated with a model ID, a machine learning function, or a machine learning use case. The processing may be performed, e.g., by the machine learning component 198. The processing may include any of the aspects described in connection with FIG. 4, 5, or 7-13.

At 1410, the device reports data via the wireless communication based on a configuration associated with the model ID, the machine learning function, or the machine learning use case. The reporting may be performed, e.g., by the machine learning component 198. The reporting may include any of the aspects described in connection with any of FIG. 7-10, 12, or 13, for example. The data may be reported in at least one of an RRC message, a MAC-CE, UCI, or DCI. In some aspects, at 1410, the device may report different data based on multiple configurations, each configuration associated with a different the model ID, a different machine learning function, or a different machine learning use case.

As illustrated at 1402, the device may receive the configuration identifying the model ID, the machine learning function, or the machine learning use case, where reporting the data includes transmitting the data based on a condition, timing, or periodicity indicated in the configuration for the model ID, the machine learning function, or the machine learning use case. The reception may be performed, e.g., by the machine learning component 198. The configuration associated with the model ID, the machine learning function, or the machine learning use case may indicate one or more of: a data reporting method, at least one input parameter for the machine learning, unprocessed data to obtain model input parameters, at least one measurement to obtain the model input parameters, at least one data processing module, timing for the data reporting, a condition for the data reporting, or a periodicity for the data reporting. In some aspects, the method may be performed at a UE, where the configuration is received from a network node and the data is reported to the network node. In some aspects, the method may be performed at a network node, and the configuration may be received from a UE and the data is reported to the UE. In some aspects, the method may be performed at a first network node, and the configuration may be received from a second network node and the data is reported to the second network node. In some aspects, the method may be performed at a first UE, and the configuration may be received from a second UE and the data is reported to the second UE.

As illustrated at 1404, the device may receive an activation of data reporting for the model ID, the machine learning function, or the machine learning use case, wherein the data is reported in response to the activation. The reception may be performed, e.g., by the machine learning component 198. The activation may be in a MAC-CE or a DCI, for example. An example activation is described in connection with FIG. 13.

As illustrated at 1412, the device may receive a deactivation of data reporting for the model ID, the machine learning function, or the machine learning use case. The deactivation may be in a MAC-CE or a DCI, for example. The reception may be performed, e.g., by the machine learning component 198. An example deactivation is described in connection with FIG. 13. In response to the deactivation, the device may stop the data reporting at 1414 for the model ID, the machine learning function, or the machine learning use case in response to the deactivation. FIG. 13 illustrates an example of a device stopping the data reporting in response to a deactivation. The stopping may be performed, e.g., by the machine learning component 198.

The configuration associated with the model ID, the machine learning function, or the machine learning use case may include a data validation configuration. As illustrated at 1408, the device may validate the data prior to the reporting based on a criteria of the data validation configuration for the model ID, the machine learning function, or the machine learning use case. The validation may be performed, e.g., by the machine learning component 198. Example aspects of validation are described in connection with FIGS. 7-9, 11, 12, and 13, for example. The data validation configuration may include one or more of: at least one rule for data validation associated with the model ID, the machine learning function, or the machine learning use case, at least one data statistic associated with the model ID, the machine learning function, or the machine learning use case, or at least one data property associated with the model ID, the machine learning function, or the machine learning use case.

In some aspects, validating the data, at 1408, may include identifying at least one of an inference or training output based on the machine learning that does not meet the validation criteria of the data validation configuration associated with the model ID, the machine learning function, or the machine learning use case. In response, the device may indicate a data validation failure according to the configuration for the model ID, the machine learning function, or the machine learning use case, e.g., as illustrated in FIG. 11 or 13. In some aspects, indicating the data validation failure may further indicate a transition to a procedure without the machine learning.

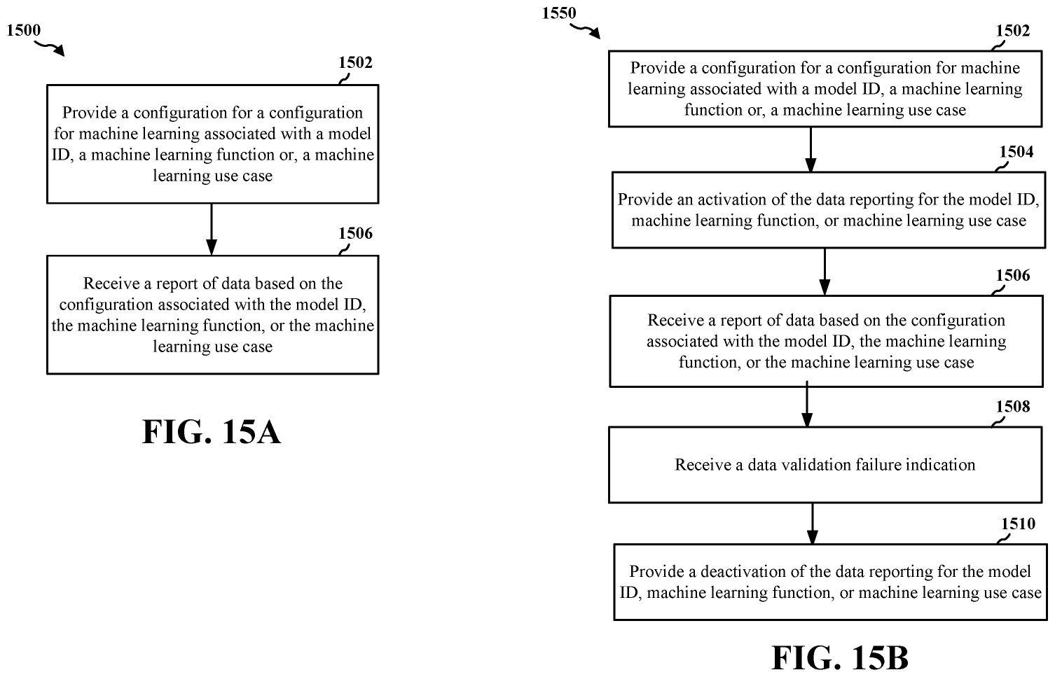

FIG. 15A is a flowchart 1500 of a method of wireless communication. In some aspects, the method may be performed by a UE (e.g., the UE 104, 350, 602, 704, 804, 904, 1302, the second device 1002, 1102; the apparatus 1604). In some aspects, the method may be performed by a network node such as a base station, a component of a base station or a device implementing base station functionality (e.g., the base station 102, 310, 1304; the network node 702, 802, 902; the second device 1002, 1102; the network entity 1702.

At 1502, the device provides a configuration for machine learning associated with a model ID, a machine learning function or, a machine learning use case. The providing of the configuration may be performed, e.g., by the machine learning configuration component 199. The configuration associated with the model ID, the machine learning function, or the machine learning use case may indicate one or more of: a data reporting method, at least one input parameter for the machine learning, unprocessed data to obtain model input parameters, at least one measurement to obtain the model input parameters, at least one data processing module, timing for the data reporting, a condition for the data reporting, or a periodicity for the data reporting. FIGS. 7-13 describe various examples of a configuration being provided for the collection, processing, validation, and/or reporting of data using an AI/ML model.

At 1506, the device receives a report of data based on the configuration associated with the model ID, the machine learning function, or the machine learning use case. The reception may be performed, e.g., by the machine learning configuration component 199. In some aspects, the method may be performed at a UE, where the configuration is provided to a network node and the data is received from the network node. In some aspects, the method may be performed at a network node, and the configuration may be provided to a UE and the data may be reported by the UE. In some aspects, the method may be performed at a first network node, and the configuration may be provided to a second network node that reports the data to the second network node. In some aspects, the method may be performed at a first UE, and the configuration may be provided to a second UE that reports the data is reported to the first UE. The reporting may include any of the aspects described in connection with any of FIG. 7-10, 12, or 13, for example. The data may be reported in at least one of an RRC message, a MAC-CE, UCI, or DCI.

In some aspects, the method may be performed at a UE, and wherein the configuration is provided to a network node and the data is received from the network node. In some aspects, the method may be performed at a network node, and wherein the configuration is provided to a UE and the data is received from the UE. In some aspects, the method may be performed at a first network node, and wherein the configuration is provided to a second network node and the data is received from the second network node. In some aspects, the method may be performed at a first UE, and wherein the configuration is provided to a second UE and the data is received from the second UE.

FIG. 15B is a flowchart 1550 of a method of wireless communication. In some aspects, the method may be performed by a UE (e.g., the UE 104, 350, 602, 704, 804, 904, 1302, the second device 1002, 1102; the apparatus 1604). In some aspects, the method may be performed by a network node such as a base station, a component of a base station or a device implementing base station functionality (e.g., the base station 102, 310, 1304; network node 702, 802, 902; the second device 1002, 1102; the network entity 1702.

At 1502, the device provides a configuration for machine learning associated with a model ID, a machine learning function or, a machine learning use case. The providing of the configuration may be performed, e.g., by the machine learning configuration component 199. The configuration associated with the model ID, the machine learning function, or the machine learning use case may indicate one or more of: a data reporting method, at least one input parameter for the machine learning, unprocessed data to obtain model input parameters, at least one measurement to obtain the model input parameters, at least one data processing module, timing for the data reporting, a condition for the data reporting, or a periodicity for the data reporting. FIGS. 7-13 describe various examples of a configuration being provided for the collection, processing, validation, and/or reporting of data using an AI/ML model.

At 1506, the device receives a report of data based on the configuration associated with the model ID, the machine learning function, or the machine learning use case. The reception may be performed, e.g., by the machine learning configuration component 199. In some aspects, the method may be performed at a UE, where the configuration is provided to a network node and the data is received from the network node. In some aspects, the method may be performed at a network node, and the configuration may be provided to a UE and the data may be reported by the UE. In some aspects, the method may be performed at a first network node, and the configuration may be provided to a second network node that reports the data to the second network node. In some aspects, the method may be performed at a first UE, and the configuration may be provided to a second UE that reports the data is reported to the first UE. The reporting may include any of the aspects described in connection with any of FIG. 7-10, 12, or 13, for example. The data may be reported in at least one of an RRC message, a MAC-CE, UCI, or DCI. In some aspects, the device may receive reports of different data based on multiple configurations, each configuration associated with a different model ID, a different machine learning function, or a different machine learning use case. The reception may be performed, e.g., by the machine learning configuration component 199. The report of the data may include any of the aspects described in connection with any of FIG. 7-10, 12, or 13, for example. The data may be received in at least one of an RRC message, a MAC-CE, UCI, or DCI.

In some aspects, the method may be performed at a UE, and wherein the configuration is provided to a network node and the data is received from the network node. In some aspects, the method may be performed at a network node, and wherein the configuration is provided to a UE and the data is received from the UE. In some aspects, the method may be performed at a first network node, and wherein the configuration is provided to a second network node and the data is received from the second network node. In some aspects, the method may be performed at a first UE, and wherein the configuration is provided to a second UE and the data is received from the second UE.

As illustrated at 1504, the device may further provide an activation of data reporting for the model ID, the machine learning function, or the machine learning use case, wherein the data is received in response to the activation. The providing of the activation may be performed, e.g., by the machine learning configuration component 199. An example activation is described in connection with FIG. 13.

As illustrated at 1510, the device may further provide a deactivation of data reporting for the model ID, the machine learning function, or the machine learning use case. The providing of the deactivation may be performed, e.g., by the machine learning configuration component 199. An example deactivation is described in connection with FIG. 13.

The configuration associated with the model ID may include a data validation configuration that includes one or more of: at least one rule for data validation associated with the model ID, the machine learning function, or the machine learning use case, at least one data statistic associated with the model ID, the machine learning function, or the machine learning use case, or at least one data property associated with the model ID, the machine learning function, or the machine learning use case. As illustrated at 1508, the device may receive a data validation failure indication indicating at least one of an inference or training output based on the machine learning that does not meet validation criteria of the data validation configuration associated with the model ID, the machine learning function, or the machine learning use case. The reception may be performed, e.g., by the machine learning configuration component 199. Example aspects of data validation failure are described in connection with FIGS. 11 and 13, for example. The data validation failure may further indicate a transition to a procedure without the machine learning.

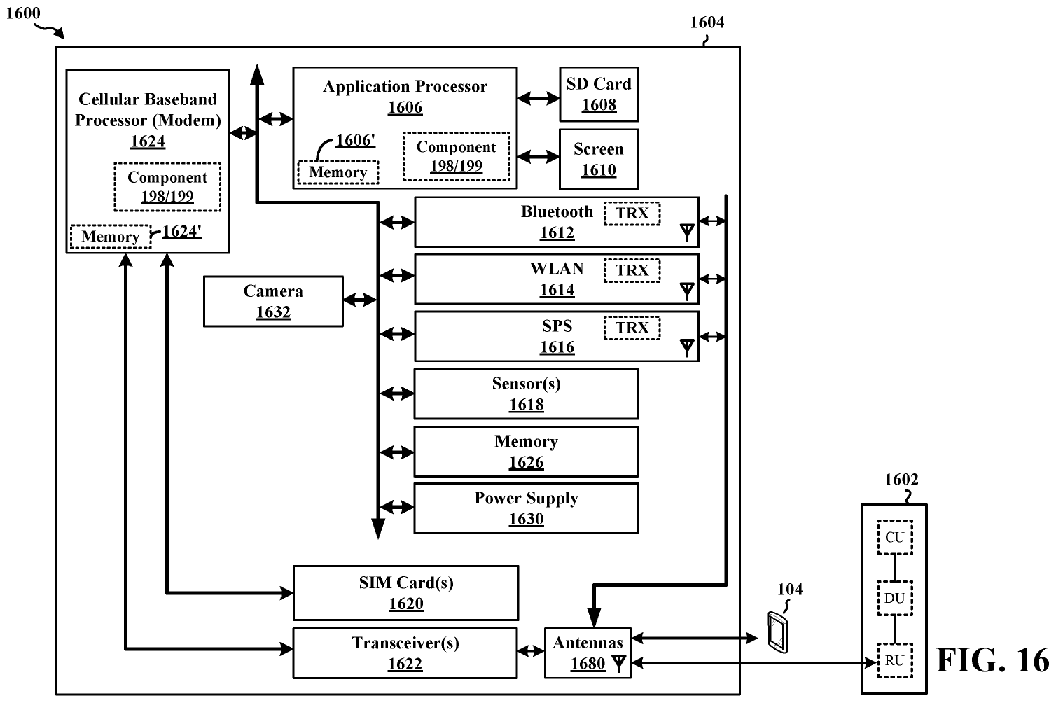

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include a cellular baseband processor 1624 (also referred to as a modem) coupled to one or more transceivers 1622 (e.g., cellular RF transceiver). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor 1624 communicates through the transceiver(s) 1622 via one or more antennas 1680 with the UE 104 and/or with an RU associated with a network entity 1602. The cellular baseband processor 1624 and the application processor 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described supra. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the TX processor 368, the RX processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., see 350 of FIG. 3) and include the additional modules of the apparatus 1604.

As discussed herein, the machine learning component 198 may be configured to process information with machine learning associated with a model ID, a machine learning function, or a machine learning use case; and reporting data via the wireless communication based on a configuration associated with the model ID, the machine learning function, or the machine learning use case. The machine learning component 198 may be further configured to perform any of the aspects described in connection with the flowchart in FIGS. 14A and/or 14B, the algorithm in FIG. 4, and/or the aspects performed by the first device 1104 in FIG. 11, the UE in any of FIG. 6, 8, 9,10, or 13, the network node in FIG. 7. As described above the machine learning configuration component 199 may be configured to provide a configuration for machine learning associated with a model ID, a machine learning function or, a machine learning use case; and receive a report of data based on the configuration associated with the model ID, the machine learning function, or the machine learning use case. The machine learning configuration component 199 may be further configured to perform any of the aspects described in connection with the flowchart in FIGS. 15A and/or 15B, the algorithm in FIG. 4, and/or the aspects performed by the second device 1102 in FIG. 11, the network node in any of FIG. 6, 8, 9,10, or 13, the UE in FIG. 7. The machine learning component 198 and/or the machine learning configuration component 199 may be within the cellular baseband processor 1624, the application processor 1606, or both the cellular baseband processor 1624 and the application processor 1606. The machine learning component 198 and/or the machine learning configuration component may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, may include apparatus 1604 may include means for processing information with machine learning associated with a model ID, a machine learning function, or a machine learning use case; and means for reporting data via the wireless communication based on a configuration associated with the model ID, the machine learning function, or the machine learning use case. The apparatus 1604 may further include means for receiving the configuration identifying the model ID, the machine learning function, or the machine learning use case, wherein reporting the data includes transmitting the data based on a condition, timing, or periodicity indicated in the configuration for the model ID, the machine learning function, or the machine learning use case. The apparatus 1604 may further include means for reporting different data based on multiple configurations, each configuration associated with a different the model ID, a different machine learning function, or a different machine learning use case. The apparatus 1604 may further include means for receiving an activation of data reporting for the model ID, the machine learning function, or the machine learning use case, wherein the data is reported in response to the activation. The apparatus 1604 may further include means for receiving a deactivation of data reporting for the model ID, the machine learning function, or the machine learning use case; and means for stopping the data reporting for the model ID, the machine learning function, or the machine learning use case in response to the deactivation. The configuration associated with the model ID, the machine learning function, or the machine learning use case may include a data validation configuration, and the apparatus 1604 may further include means for validating the data prior to the reporting based on a criteria of the data validation configuration for the model ID, the machine learning function, or the machine learning use case. The apparatus 1604 may further include means for identifying at least one of an inference or training output based on the machine learning that does not meet the validation criteria of the data validation configuration associated with the model ID, the machine learning function, or the machine learning use case; and means for indicating a data validation failure according to the configuration for the model ID, the machine learning function, or the machine learning use case. The apparatus 1604 may include means for performing any of the aspects described in connection with the flowchart in FIGS. 14A and/or 14B, the algorithm in FIG. 4, and/or the aspects performed by the first device 1104 in FIG. 11, the UE in any of FIG. 6, 8, 9,10, or 13, the network node in FIG. 7. In some aspects, the apparatus 1604 may include means for providing a configuration for machine learning associated with a model ID, a machine learning function or, a machine learning use case; and means for receiving a report of data based on the configuration associated with the model ID, the machine learning function, or the machine learning use case. The apparatus 1604 may further include means for receiving reports of different data based on multiple configurations, each configuration associated with a different model ID, a different machine learning function, or a different machine learning use case. The apparatus 1604 may further include means for means for providing an activation of data reporting for the model ID, the machine learning function, or the machine learning use case, wherein the data is received in response to the activation. The apparatus 1604 may further include means for providing a deactivation of data reporting for the model ID, the machine learning function, or the machine learning use case. The apparatus 1604 may further include means for receiving a data validation failure indicating at least one of an inference or training output based on the machine learning that does not meet validation criteria of the data validation configuration associated with the model ID, the machine learning function, or the machine learning use case. The apparatus 1604 may further include means for performing any of the aspects described in connection with the flowchart in FIGS. 15A and/or 15B, the algorithm in FIG. 4, and/or the aspects performed by the second device 1102 in FIG. 11, the network node in any of FIG. 6, 8, 9,10, or 13, the UE in FIG. 7. The means may be the machine learning component 198 and/or the machine learning configuration component 199 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

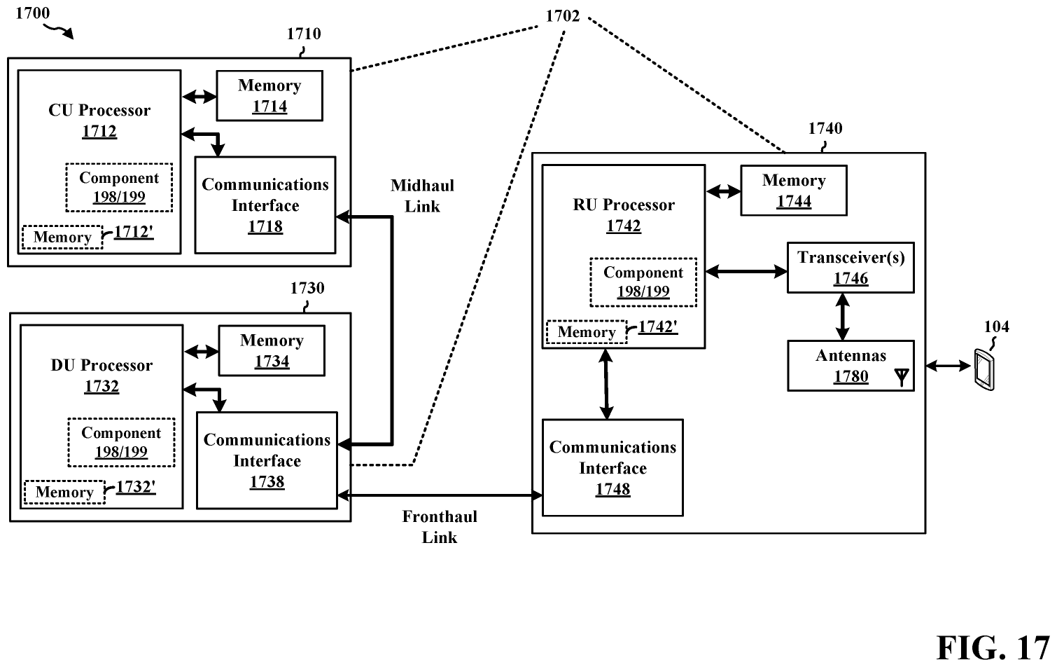

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the machine learning configuration component 199 and/or the machine learning component 198, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include a CU processor 1712. The CU processor 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include a DU processor 1732. The DU processor 1732 may include on-chip memory 1732′. In some aspects, the DU 1730 may further include additional memory modules 1734 and a communications interface 1738. The DU 1730 communicates with the RU 1740 through a fronthaul link. The RU 1740 may include an RU processor 1742. The RU processor 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed herein, the machine learning component 198 may be configured to process information with machine learning associated with a model ID, a machine learning function, or a machine learning use case; and reporting data via the wireless communication based on a configuration associated with the model ID, the machine learning function, or the machine learning use case. The machine learning component 198 may be further configured to perform any of the aspects described in connection with the flowchart in FIGS. 14A and/or 14B, the algorithm in FIG. 4, and/or the aspects performed by the first device 1104 in FIG. 11, the UE in any of FIG. 6, 8, 9,10, or 13, the network node in FIG. 7. As described above the machine learning configuration component 199 may be configured to provide a configuration for machine learning associated with a model ID, a machine learning function or, a machine learning use case; and receive a report of data based on the configuration associated with the model ID, the machine learning function, or the machine learning use case. The machine learning configuration component 199 may be further configured to perform any of the aspects described in connection with the flowchart in FIGS. 15A and/or 15B, the algorithm in FIG. 4, and/or the aspects performed by the second device 1102 in FIG. 11, the network node in any of FIG. 6, 8, 9,10, or 13, the UE in FIG. 7. The machine learning configuration component 199 and/or the machine learning component 198 may be within one or more processors of one or more of the CU 1710, DU 1730, and the RU 1740. The machine learning configuration component 199 and/or the machine learning component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1702 may include a variety of components configured for various functions. In one configuration, the network entity 1702 may include means for processing information with machine learning associated with a model ID, a machine learning function, or a machine learning use case; and means for reporting data via the wireless communication based on a configuration associated with the model ID, the machine learning function, or the machine learning use case. The network entity 1702 may further include means for receiving the configuration identifying the model ID, the machine learning function, or the machine learning use case, wherein reporting the data includes transmitting the data based on a condition, timing, or periodicity indicated in the configuration for the model ID, the machine learning function, or the machine learning use case. The network entity 1702 may further include means for reporting different data based on multiple configurations, each configuration associated with a different the model ID, a different machine learning function, or a different machine learning use case. The network entity 1702 may further include means for receiving an activation of data reporting for the model ID, the machine learning function, or the machine learning use case, wherein the data is reported in response to the activation. The network entity 1702 may further include means for receiving a deactivation of data reporting for the model ID, the machine learning function, or the machine learning use case; and means for stopping the data reporting for the model ID, the machine learning function, or the machine learning use case in response to the deactivation. The configuration associated with the model ID, the machine learning function, or the machine learning use case may include a data validation configuration, and the network entity 1702 may further include means for validating the data prior to the reporting based on a criteria of the data validation configuration for the model ID, the machine learning function, or the machine learning use case. The network entity 1702 may further include means for identifying at least one of an inference or training output based on the machine learning that does not meet the validation criteria of the data validation configuration associated with the model ID, the machine learning function, or the machine learning use case; and means for indicating a data validation failure according to the configuration for the model ID, the machine learning function, or the machine learning use case. The network entity 1702 may include means for performing any of the aspects described in connection with the flowchart in FIGS. 14A and/or 14B, the algorithm in FIG. 4, and/or the aspects performed by the first device 1104 in FIG. 11, the UE in any of FIG. 6, 8, 9,10, or 13, the network node in FIG. 7. In some aspects, the network entity 1702 may include for providing a configuration for machine learning associated with a model ID, a machine learning function or, a machine learning use case; and means for receiving a report of data based on the configuration associated with the model ID, the machine learning function, or the machine learning use case. The network entity 1702 may further include means for receiving reports of different data based on multiple configurations, each configuration associated with a different model ID, a different machine learning function, or a different machine learning use case. The network entity 1702 may further include means for means for providing an activation of data reporting for the model ID, the machine learning function, or the machine learning use case, wherein the data is received in response to the activation. The network entity 1702 may further include means for providing a deactivation of data reporting for the model ID, the machine learning function, or the machine learning use case. The network entity 1702 may further include means for receiving a data validation failure indicating at least one of an inference or training output based on the machine learning that does not meet validation criteria of the data validation configuration associated with the model ID, the machine learning function, or the machine learning use case. The network entity may include means for performing any of the aspects described in connection with the flowchart in FIGS. 15A and/or 15B, the algorithm in FIG. 4, and/or the aspects performed by the second device 1102 in FIG. 11, the network node in any of FIG. 6, 8, 9,10, or 13, the UE in FIG. 7. The means may be the machine learning configuration component 199 and/or the machine learning component 198 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

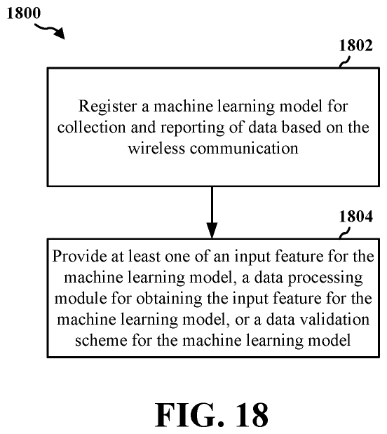

FIG. 18 is a flowchart 1800 of a method of registering an AI/ML model in accordance with the aspects presented herein. At 1802, the model designer may register a machine learning model for collection and reporting of data based on the wireless communication. FIGS. 7-10 illustrate various aspects of a model designer registering an AI/ML model.

At 1804, the model designer may provide at least one of an input feature for the machine learning model, a data processing module for obtaining the input feature for the machine learning model, or a data validation scheme for the machine learning model. The data validation scheme may include one or more of: at least one rule for data validation associated with the machine learning model, at least one data statistic associated with training data for the machine learning model, at least one data statistic associated with inference data for the machine learning model, at least one data property associated with the training data for the machine learning model, or at least one data property associated with the inference data for the machine learning model.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

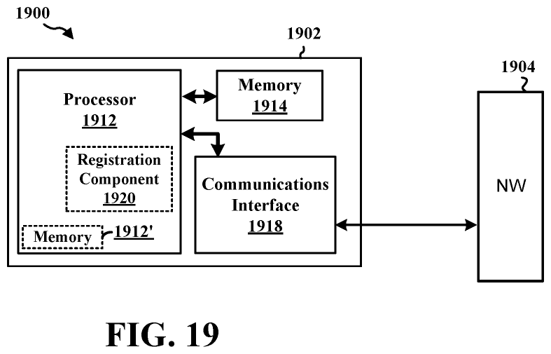

FIG. 19 is a diagram 1900 illustrating an example of a hardware implementation for a model registration entity 1902. The model registration entity 1902 may include on-chip memory 1912′. In some aspects, the model registration entity 1902 may further include additional memory modules 1914 and a communications interface 1918. The on-chip memory 1912′ and the additional memory module 1914 may each be considered a computer-readable medium/memory. Each computer-readable medium/memory may be non-transitory. The processor(s) 1912 may be responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As described above the registration component 1920 may be configured to register a machine learning model for collection and reporting of data based on the wireless communication; and to provide at least one of an input feature for the machine learning model, a data processing module for obtaining the input feature for the machine learning model, or a data validation scheme for the machine learning model to a network entity 1904. The registration component 1920 may be configured to perform any of the aspects in FIG. 18 and/or. The registration component 1920 may be within one or more processors of the model registration entity 1902. The registration component 1920 may be one or more hardware components specifically configured to carry out the stated processes/algorithm, implemented by one or more processors configured to perform the stated processes/algorithm, stored within a computer-readable medium for implementation by one or more processors, or some combination thereof. The model registration entity 1902 may include a variety of components configured for various functions. In one configuration, the model registration entity 1902 may include means for registering a machine learning model for collection and reporting of data based on the wireless communication; and means for providing at least one of an input feature for the machine learning model, a data processing module for obtaining the input feature for the machine learning model, or a data validation scheme for the machine learning model. The model registration entity 1902 may include means for performing any of the aspects described in connection with the flowchart in FIG. 18, and/or the aspects performed by the model designer in any of FIGS. 7-10. The means may be the registration component 1920 of the model registration entity 1902 configured to perform the functions recited by the means.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication, including: processing information with machine learning associated with a model ID, a machine learning function, or a machine learning use case; and reporting data via the wireless communication based on a configuration associated with the model ID, the machine learning function, or the machine learning use case.

In aspect 2, the method of aspect 1 further includes receiving the configuration identifying the model ID, the machine learning function, or the machine learning use case, wherein reporting the data includes transmitting the data based on a condition, timing, or periodicity indicated in the configuration for the model ID, the machine learning function, or the machine learning use case.

In aspect 3, the method of aspect 2 further includes that the method is performed at a UE, and wherein the configuration is received from a network node and the data is reported to the network node.

In aspect 4, the method of aspect 2 further includes that the method is performed at a network node, and wherein the configuration is received from a UE and the data is reported to the UE.

In aspect 5, the method of aspect 2 further includes that method is performed at a first network node, and wherein the configuration is received from a second network node and the data is reported to the second network node.

In aspect 6, the method of aspect 2 further includes that the method is performed at a first UE, and wherein the configuration is received from a second UE and the data is reported to the second UE.

In aspect 7, the method of any of aspects 1-6 further includes that the configuration associated with the model ID, the machine learning function, or the machine learning use case indicates one or more of: a data reporting method, at least one input parameter for the machine learning, unprocessed data to obtain model input parameters, at least one measurement to obtain the model input parameters, at least one data processing module, timing for a data reporting, a condition for the data reporting, or a periodicity for the data reporting.

In aspect 8, the method of any of aspects 1-7 further includes reporting different data based on multiple configurations, each configuration associated with a different the model ID, a different machine learning function, or a different machine learning use case.

In aspect 9, the method of any of aspects 1-8 further includes receiving a data reporting activation for the model ID, the machine learning function, or the machine learning use case, wherein the data is reported in response to the activation.

In aspect 10, the method of any of aspects 1-9 further includes receiving a data reporting deactivation for the model ID, the machine learning function, or the machine learning use case; and stopping the reporting of the data for the model ID, the machine learning function, or the machine learning use case in response to the deactivation.

In aspect 11, the method of any of aspects 1-10 further includes the data is reported in at least one of an RRC message, a MAC-CE, UCI, or DCI.

In aspect 12, the method of any of aspects 1-11 further includes the configuration associated with the model ID, the machine learning function, or the machine learning use case includes a data validation configuration, the method further comprising: validating the data prior to the reporting based on a criteria of the data validation configuration for the model ID, the machine learning function, or the machine learning use case.

In aspect 13, the method of aspect 12 further includes that the data validation configuration includes one or more of: at least one rule for data validation associated with the model ID, the machine learning function, or the machine learning use case, at least one data statistic associated with the model ID, the machine learning function, or the machine learning use case, or at least one data property associated with the model ID, the machine learning function, or the machine learning use case.

In aspect 14, the method of aspect 12 or aspect 13 further includes identifying at least one of an inference or training output based on the machine learning that does not meet the criteria of the data validation configuration associated with the model ID, the machine learning function, or the machine learning use case; and indicating a data validation failure according to the configuration for the model ID, the machine learning function, or the machine learning use case.

In aspect 15, the method of aspect 14 further includes indicating the data validation failure further indicates a transition to a procedure without the machine learning.

Aspect 16 is an apparatus for wireless communication including means for performing the method of any of aspects 1-15.

Aspect 17 is an apparatus for wireless communication including a memory; and at least one processor coupled to the memory and, based at least in part on information stored in the memory, the at least one processor is configured to perform the method of any of aspects 1-15.

In aspect 18, the apparatus of aspect 16 or aspect 17 further includes at least one transceiver or at least one antenna coupled to the at least one processor.

Aspect 19 is a non-transitory computer-readable medium storing computer executable code, the code when executed by at least one processor causes the at least one processor to implement a method as in any of aspects 1-15.

Aspect 20 is a method of wireless communication, including: providing a configuration for machine learning associated with a model ID, a machine learning function or, a machine learning use case; and receiving a report of data based on the configuration associated with the model ID, the machine learning function, or the machine learning use case.

In aspect 21, the method of aspect 20 further includes that the configuration associated with the model ID, the machine learning function, or the machine learning use case indicates one or more of: a data reporting method, at least one input parameter for the machine learning, unprocessed data to obtain model input parameters, at least one measurement to obtain the model input parameters, at least one data processing module, timing for a data reporting, a condition for the data reporting, or a periodicity for the data reporting.

In aspect 22, the method of aspect 20 or aspect 21 further includes receiving reports of different data based on multiple configurations, each configuration associated with a different model ID, a different machine learning function, or a different machine learning use case.

In aspect 23, the method of any of aspects 20-22 further includes providing a data reporting activation for the model ID, the machine learning function, or the machine learning use case, wherein the data is received in response to the activation.

In aspect 24, the method of any of aspects 20-23 further includes providing a data reporting deactivation for the model ID, the machine learning function, or the machine learning use case.

In aspect 25, the method of any of aspects 20-24 further includes that the data is received in at least one of an RRC message, a MAC-CE, UCI, or DCI.

In aspect 26, the method of any of aspects 20-25 further includes that the configuration associated with the model ID includes a data validation configuration, including one or more of: at least one rule for data validation associated with the model ID, the machine learning function, or the machine learning use case, at least one data statistic associated with the model ID, the machine learning function, or the machine learning use case, or at least one data property associated with the model ID, the machine learning function, or the machine learning use case.

In aspect 27, the method of aspect 26 further includes receiving a data validation failure indicating at least one of an inference or training output based on the machine learning that does not meet validation criteria of the data validation configuration associated with the model ID, the machine learning function, or the machine learning use case.

In aspect 28, the method of aspect 27 further includes indicating the data validation failure further indicates a transition to a procedure without the machine learning.

In aspect 29, the method of any of aspects 20-28 further includes that the method is performed at a UE, and wherein the configuration is provided to a network node and the data is received from the network node.

In aspect 30, the method of any of aspects 20-28 further includes that the method is performed at a network node, and wherein the configuration is provided to a UE and the data is received from the UE.

In aspect 31, the method of any of aspects 20-28 further includes that method is performed at a first network node, and wherein the configuration is provided to a second network node and the data is received from the second network node.

In aspect 32, the method of any of aspects 20-28 further includes that the method is performed at a first UE, and wherein the configuration is provided to a second UE and the data is received from the second UE.

Aspect 33 is an apparatus for wireless communication including means for performing the method of any of aspects 20-32.

Aspect 34 is an apparatus for wireless communication including a memory; and at least one processor coupled to the memory and, based at least in part on information stored in the memory, the at least one processor is configured to perform the method of any of aspects 20-32.

In aspect 35, the apparatus of aspect 33 or aspect 34 further includes at least one transceiver or at least one antenna coupled to the at least one processor.

Aspect 36 is a non-transitory computer-readable medium storing computer executable code, the code when executed by at least one processor causes the at least one processor to implement a method as in any of aspects 20-32.

Aspect 37 is a method of wireless communication, including: registering a machine learning model for collection and reporting of data based on the wireless communication; and providing at least one of an input feature for the machine learning model, a data processing module for obtaining the input feature for the machine learning model, or a data validation scheme for the machine learning model.

In aspect 38, the method of aspect 37 further includes that the data validation scheme includes one or more of: at least one rule for data validation associated with the machine learning model, at least one first data statistic associated with training data for the machine learning model, at least one second data statistic associated with inference data for the machine learning model, at least one first data property associated with the training data for the machine learning model, or at least one second data property associated with the inference data for the machine learning model.

Aspect 39 is an apparatus for wireless communication including means for performing the method of any of aspects 37-38.

Aspect 40 is an apparatus for wireless communication including a memory; and at least one processor coupled to the memory and, based at least in part on information stored in the memory, the at least one processor is configured to perform the method of any of aspects 37-38.

In aspect 41, the apparatus of aspect 39 or aspect 40 further includes at least one transceiver or at least one antenna coupled to the at least one processor.

Aspect 42 is a non-transitory computer-readable medium storing computer executable code, the code when executed by at least one processor causes the at least one processor to implement a method as in any of aspects 37-38.

1. An apparatus for wireless communication, including:
a memory; and
at least one processor coupled to the memory and, based at least in part on information stored in the memory, the at least one processor is configured to:
process information with machine learning associated with a model identifier (ID), a machine learning function, or a machine learning use case; and
report data via the wireless communication based on a configuration associated with the model ID, the machine learning function, or the machine learning use case.

2. The apparatus of claim 1, further comprising:
a transceiver coupled to the at least one processor, wherein the at least one processor is further configured to:
receive the configuration identifying the model ID, the machine learning function, or the machine learning use case, wherein reporting the data includes transmitting the data based on a condition, timing, or periodicity indicated in the configuration for the model ID, the machine learning function, or the machine learning use case.

3. The apparatus of claim 2, wherein the apparatus is for the wireless communication at a user equipment (UE), and the at least one processor is configured to receive the configuration from a network node and report the data to the network node.

4. The apparatus of claim 2, wherein the apparatus is for the wireless communication at a network node, and the at least one processor is configured to receive the configuration from a user equipment (UE) and report the data to the UE.

5. The apparatus of claim 2, wherein the apparatus is for the wireless communication at a first network node, and the at least one processor is configured to receive the configuration from a second network node and report the data to the second network node.

6. The apparatus of claim 2, wherein the apparatus is for the wireless communication at a first user equipment (UE), and the at least one processor is configured to receive the configuration from a second UE and report the data to the second UE.

7. The apparatus of claim 1, wherein the configuration associated with the model ID, the machine learning function, or the machine learning use case indicates one or more of:
a data reporting method,
at least one input parameter for the machine learning,
unprocessed data to obtain model input parameters,
at least one measurement to obtain the model input parameters,
at least one data processing module,
timing for a data reporting,
a condition for the data reporting, or
a periodicity for the data reporting.

8. The apparatus of claim 1, wherein the at least one processor is further configured to:
report different data based on multiple configurations, each configuration associated with a different the model ID, a different machine learning function, or a different machine learning use case.

9. The apparatus of claim 1, wherein the at least one processor is further configured to:
receive a data reporting activation for the model ID, the machine learning function, or the machine learning use case and to report the data in response to the activation.

10. The apparatus of claim 1, wherein the at least one processor is further configured to:
receive a data reporting deactivation for the model ID, the machine learning function, or the machine learning use case; and
stop the reporting of the data for the model ID, the machine learning function, or the machine learning use case in response to the deactivation.

11. The apparatus of claim 1, wherein the at least one processor is configured to report the data in at least one of a radio resource control (RRC) message, a medium access control-control element (MAC-CE), uplink control information (UCI) or downlink control information (DCI).

12. The apparatus of claim 1, wherein the configuration associated with the model ID, the machine learning function, or the machine learning use case includes a data validation configuration, wherein the at least one processor is further configured to:
validate the data prior to reporting based on a criteria of the data validation configuration for the model ID, the machine learning function, or the machine learning use case.

13. The apparatus of claim 12, wherein the data validation configuration including one or more of:
at least one rule for data validation associated with the model ID, the machine learning function, or the machine learning use case,
at least one data statistic associated with the model ID, the machine learning function, or the machine learning use case, or
at least one data property associated with the model ID, the machine learning function, or the machine learning use case.

14. The apparatus of claim 12, wherein the at least one processor is further configured to:
identify at least one of an inference or training output based on the machine learning that does not meet the criteria of the data validation configuration associated with the model ID, the machine learning function, or the machine learning use case; and
indicate a data validation failure according to the configuration for the model ID, the machine learning function, or the machine learning use case.

15. The apparatus of claim 14, wherein indicating the data validation failure further indicates a transition to a procedure without the machine learning.

16. An apparatus for wireless communication, including:
a memory; and
at least one processor coupled to the memory and, based at least in part on information stored in the memory, the at least one processor is configured to:
provide a configuration for machine learning associated with a model identifier (ID), a machine learning function or, a machine learning use case; and
receive a report of data based on the configuration associated with the model ID, the machine learning function, or the machine learning use case.

17. The apparatus of claim 16, wherein the configuration associated with the model ID, the machine learning function, or the machine learning use case indicates one or more of:
a data reporting method,
at least one input parameter for the machine learning,
unprocessed data to obtain model input parameters,
at least one measurement to obtain the model input parameters,
at least one data processing module,
timing for a data reporting,
a condition for the data reporting, or
a periodicity for the data reporting.

18. The apparatus of claim 16, further comprising:
a transceiver coupled to the at least one processor, wherein the at least one processor is further configured to:
receive reports of different data based on multiple configurations, each configuration associated with a different model ID, a different machine learning function, or a different machine learning use case.

19. The apparatus of claim 16, wherein the at least one processor is further configured to:
provide a data reporting activation for the model ID, the machine learning function, or the machine learning use case, wherein the data is received in response to the activation.

20. The apparatus of claim 16, wherein the at least one processor is further configured to:
provide a data reporting deactivation for the model ID, the machine learning function, or the machine learning use case.

21. The apparatus of claim 16, wherein the at least one processor is configured to receive the data in at least one of a radio resource control (RRC) message, a medium access control-control element (MAC-CE), uplink control information (UCI) or downlink control information (DCI).

22. The apparatus of claim 16, wherein the configuration associated with the model ID includes a data validation configuration, including one or more of:
at least one rule for data validation associated with the model ID, the machine learning function, or the machine learning use case,
at least one data statistic associated with the model ID, the machine learning function, or the machine learning use case, or
at least one data property associated with the model ID, the machine learning function, or the machine learning use case.

23. The apparatus of claim 22, wherein the at least one processor is further configured to:
receive a data validation failure indicating at least one of an inference or training output based on the machine learning that does not meet validation criteria of the data validation configuration associated with the model ID, the machine learning function, or the machine learning use case.

24. The apparatus of claim 23, wherein indicating the data validation failure further indicates a transition to a procedure without the machine learning.

25. An apparatus for registering a machine learning model, including:
a memory; and
at least one processor coupled to the memory and, based at least in part on information stored in the memory, the at least one processor is configured to:
register the machine learning model for collection and reporting of data based on wireless communication; and
provide at least one of an input feature for the machine learning model, a data processing module for obtaining the input feature for the machine learning model, or a data validation scheme for the machine learning model.

26. The apparatus of claim 25, wherein the data validation scheme includes one or more of:
at least one rule for data validation associated with the machine learning model,
at least one first data statistic associated with training data for the machine learning model,
at least one second data statistic associated with inference data for the machine learning model,
at least one first data property associated with the training data for the machine learning model, or
at least one second data property associated with the inference data for the machine learning model.

27. A method of wireless communication, including:
processing information with machine learning associated with a model identifier (ID), a machine learning function, or a machine learning use case; and
reporting data via the wireless communication based on a configuration associated with the model ID, the machine learning function, or the machine learning use case.

28. The method of claim 27, further comprising:
receiving the configuration identifying the model ID, the machine learning function, or the machine learning use case, wherein reporting the data includes transmitting the data based on a condition, timing, or periodicity indicated in the configuration for the model ID, the machine learning function, or the machine learning use case.

29. The method of claim 27, further including:
reporting different data based on multiple configurations, each configuration associated with a different the model ID, a different machine learning function, or a different machine learning use case.

30. The method of claim 27, wherein the configuration associated with the model ID, the machine learning function, or the machine learning use case includes a data validation configuration, the method further comprising:
validating the data prior to the reporting based on a criteria of the data validation configuration for the model ID, the machine learning function, or the machine learning use case.
